(19) United States
(12) Patent Application Publication
(10) Pub. No.: US 2009/0198630 A1
(43) Pub. Date: Aug. 6, 2009

(54) Systems and methods for investing

(76) Inventors: William Bennett Treitler, San Diego, CA (US); Mark Edward Stutzman, San Diego, CA (US); Douglas Walter Miller, Alpine, CA (US); Jerrold Robin Sexton, Escondido, CA (US)

Correspondence Address: Locke Lord Bissell & Liddell LLP, 111 S. Wacker Drive, Chicago, IL, 60606-4410, US

(21) Appl. No.: 12/322,259

(22) Filed: Jan. 30, 2009

Related U.S. Application Data
(60) Provisional application No. 61/063,282, filed on Feb. 1, 2008.

(51) Int. Cl. G06Q 40/00

(52) U.S. Cl. 705/36 R

(57) ABSTRACT

The present invention provides unique systems and methods for investors to invest in a new start-up, potential high growth or other company or business entity, and potentially make a substantial return on their investment while minimizing the risk of a loss of invested capital (i.e., having a maximized risk/investment return ratio), using a unique combination of various investment vehicles and insurance and annuity products, including in force non-variable (or other) life insurance policies held on individuals preferably ranging in age from about 70 to about 80 years, Single Premium Immediate Annuities, and LIBAC^{SM} distributions, to provide the assurance of return of invested capital. Additionally, these systems and methods advantageously may generate assets and revenue that may help a new start-up or potential high growth company to “go public.”

### FIELD OF THE INVENTION

This application is a non-provisional patent application that is being filed from, and claims the benefit of, prior pending Provisional Patent Application U.S. Ser. No. 61/063,282, filed on Feb. 1, 2008. Provisional Patent Application U.S. Ser. No. 61/063,282 is hereby incorporated into this non-provisional patent application in its entirety by reference.

The present invention relates to unique and very advantageous vehicles and methods for investors to invest in new, start-up, potential high growth, or other, companies or business entities, and potentially make a substantial return on their investment while also minimizing the risk of a loss of invested capital (i.e., having a maximized risk/investment return ratio), using a unique combination of various investment vehicles and insurance products, including in force non-variable (or other) life insurance policies held on individuals ranging in age from about 65 to about 85 years, Single Premium Immediate Annuities, and LIBAC^{SM} distributions, to provide the assurance of return of invested capital. Additionally, these systems and methods advantageously may generate assets and revenue that may help a new start-up or potential high growth company to “go public,” rather than remain private.

### BACKGROUND OF THE INVENTION

1. Background

A 1911 U.S. Supreme Court case established a life insurance policyowner's right to transfer an insurance policy. The Court noted that life insurance possesses all the ordinary characteristics of property and, therefore, represented an asset that a life insurance policyowner could transfer without limitation, and that life insurance has become a form of investment and self-compelled saving. This opinion placed the ownership rights in a life insurance policy on the same legal footing as more traditional investment property, such as stocks and bonds. As with these other types of property, a life insurance policy could be transferred to another person at the discretion of the policyowner. This decision established that a life insurance policy is transferable property that contains specific legal rights, including the right to:
Name the policy beneficiary;
Change the beneficiary designation (unless subject to restrictions);
Assign the policy as collateral for a loan;
Borrow against the policy; and
Sell the policy to another party.

Further, in 2001, The National Association of Insurance Commissioners (NAIC) released the Viatical Settlements Model Act defining guidelines for avoiding fraud and ensuring sound business practices. Around this time, many of the life settlement providers that are prominent today began purchasing life insurance policies for their investment portfolios using institutional capital. The arrival of well-funded corporate entities transformed the settlement concept into a regulated wealth management tool for high-net-worth life insurance policyowners who no longer needed a given policy. Strong demand for life insurance settlements is driving a rapid market expansion that continues today, and is supported by the virtue of life settlements being a non-correlated asset class, meaning returns for this asset class are not directly related to traditional financial markets.

The current Life Insurance Settlement market stems from the viatical settlement market (the market for people who have a life threatening illness or disease whose life expectancy is two years or less) that arose in the 1980s out of the AIDS epidemic. The Life Insurance Settlement market has numerous financial structures for acquiring life insurance policies and funding premiums. However, there have been no instances of using settled life insurance policies as collateral for, or an asset backing, a private placement or public placement of securities in an entity whose primary business is in no way related to insurance or life settlements. The present invention is the first to very advantageously use settled life insurance policies as a means of providing a return of invested capital to investors whose primary investment focus is in an unrelated business enterprise. The present invention provides investors with a superior risk/reward ratio by providing the upside reward potential usually associated with venture capital investment, while almost eliminating the risk of a loss of principal by providing investors with the safety of a “fully funded” (future premiums, administrative expenses, and taxes incidental to the method are paid through one or more Single Premium Immediate Annuities (“SPIAs”)) portfolio of life insurance policies with a face value similar to, equal to, or greater than, the amount invested. Investment banks have looked upon this alternative non-correlated asset class as its own category of investment opportunity, but not as a tool in improving the risk/reward ratio of traditional private capital or venture capital investments.

The related art, some of which is discussed below, does not teach or suggest how practitioners of the financial transactions art may engineer a financial product using settled life insurance policies to provide assets to back more traditional venture capital and private capital investments, for which there had been a long-felt, but unsolved, need in the financial industry. Until the present invention (called “the LIBAC^{SM} system” or “the LIBAC^{SM} process”), no one had been able to devise a way to provide a settled life insurance policy, with funded premiums for the life of the Insured, at a cost that would allow the major portion of the investment to be made in a non-related venture capital or private capital transaction. Others in the financial industry have tried to devise a way to obtain Single Premium Immediate Annuities as a means of fully funding future premiums for settled life insurance policies (one aspect or step of the LIBAC^{SM} system or the LIBAC^{SM} process), but have failed. The LIBAC^{SM} system and LIBAC^{SM} process not only solve this problem, but they additionally go beyond this issue and create an entirely new use for settled life insurance policies, i.e., using the life insurance policies as a means of providing security of principal for a much larger investment in an otherwise generally high risk venture. Until the LIBAC^{SM} system and LIBAC^{SM} process, no one had thought of a vehicle or process for providing this asset at a price allowing the acquisition to be the secondary investment, principal return mechanism, for the primary larger investment, i.e. facilitating the financing of business entities unrelated to the Life Insurance Settlement market.

Furthermore, practitioners in the art have been unable to devise a business vehicle or process that creates a market for senior life insurance policies with a life expectancy of more than 12-14 years. Because the primary investment under the LIBAC^{SM} system and LIBAC^{SM} process is not the portfolio of “fully funded” life insurance policies acquired, the system and process are able to utilize these longer life expectancy life insurance policies for the portfolio and, thereby, create a market for these policies that heretofore did not exist or was de minimus.

Related art in the securities market has included the acquisition of U.S. bonds as a principal return mechanism for a primary investment in an operating business. Typically, zero coupon bonds with 25-30 year maturities have been used and cost about 25% to about 30% of total funds invested. Such bonds have a stated maturity date, and there is no chance that the total amount invested (the face value of the bonds acquired) could be returned before the maturity date. In contrast, one would expect from about 50% to about 85% of the portfolio of settled life insurance polices acquired under the LIBAC^{SM} system and LIBAC^{SM} process to mature in from about 12 to about 14 years, with a substantial portion maturing sooner, such that the return of principal may be made much sooner than with U.S. bonds. This means that such funds may be re-invested, either by a Limited Liability Company (LLC) (or similar type of entity), or by the investor from distributions, which generally results in a significant improvement in yield to the investor with respect to both this secondary investment and the overall investment. Until the LIBAC^{SM} system and LIBAC^{SM} process, no one had devised a financial product that provides a secondary investment (principal return mechanism) that comes close to the safety of U.S. bonds at a competitive price, and a price that generally more than compensates the investor for the risk differential between U.S. bonds and insurance contracts from AA rated insurance companies.

Moreover, by having an Insured place a life insurance policy to be settled in a Revocable Life Insurance Trust, and by requiring the Insured to contractually obligate him or herself to fund the Revocable Life Insurance Trust and, thereby, to obtain the required Single Premium Immediate Annuity using the Insured's life as the measuring life of the annuity, the problem of requiring an insurable interest for the life insurance and annuity policy owner, while preserving the portability of the resulting financial product (i.e., the trust powers in the Revocable Life Insurance Trust may be resold at a later date), has been solved. Others have suggested acquiring Single Premium Immediate Annuities in conjunction with acquiring settled life insurance policies, but have been unable to solve the practical obstacle that annuity carriers require an insurable interest in the life of the annuitant. While there is no legal impediment in most states for such an insurable interest, since the owner benefits from the annuitant's continued life, not death, as a practical matter annuity companies will not issue an annuity unless the annuity owner has an insurable interest in the annuitant.

Financial Industry Regulatory Authority, Inc. (“FINRA”) broker-dealers who participate in private offerings on a regular basis are typically always looking to replenish clients who invested in unsuccessful offerings. Since private placements of early stage or high growth businesses are generally high risk investments, a significant percentage of private offerings fail, resulting in the broker-dealer “burning a book of business.” By providing an investment structure by which an investor's principal is backed by a promised payout from a highly rated insurance carrier, which product is more than adequately funded through Single Premium Immediate Annuity cash flow, also issued by highly rated carriers, broker-dealers will likely achieve a higher retention rate of clients who invest in a private securities offering in which the issuer is unsuccessful.

Additionally, by virtue of Internal Revenue Code Section 72 (u)(a)(1), a Single Premium Immediate Annuity provides tax efficiencies over other methods of financing future premium payments on settled life insurance policies.

The systems and methods of the present invention are structured in a manner that minimizes the tax consequences of the financing (generally by eliminating double taxation), and optimizes the risk-reward ratio to investors by providing a potential for large return of investment that is usually associated with the high risk of undercapitalized start-up companies and/or companies with large growth potential, but with the return of principal safety net provided by the LIBAC^{SM} system and the LIBAC^{SM} process.

2. Description of the Art

A description of the art is presented below. It is apparent from a review of this art that this art does not teach or suggest the systems and methods of the present invention.

U.S. Pat. No. 5,907,828 discloses a system for analyzing and managing at least one lender owned life insurance policy on behalf of a lender to improve loan profitability, achieve investment results, and to prevent investment loss as a result of adverse tax law changes.

U.S. Pat. No. 5,926,800 discloses a system for providing loans to owners of life insurance policies who are terminally ill or aged.

U.S. Patent Application Publication No. US 2004/0243451 discloses systems and methods for a shareholder in a small or closely held company to purchase a large-scale life insurance product, independent of the limited operating budget of his company, in which he can invest a large sum of private wealth.

U.S. Patent Application Publication No. US 2004/0181436 A1 discloses methods and systems for charitable fundraising using life insurance products and annuities.

U.S. Patent Application Publication No. US 2004/0181436 A1 discloses methods for investing using life insurance products and annuities. In contrast with the systems and methods of the present invention, the resulting financial product is not used as a means of facilitating (assuring at least a return of investment) a securities offering.

U.S. Patent Application Publication No. US 2005/0251465 A1 discloses an investment vehicle that uses a hedging strategy to actively manage a common trust fund.

U.S. Patent Application Publication No. US 2006/0116941 A1 discloses an investment vehicle that is stated to aid an individual to plan for his/her retirement at a date certain without concern for market risk.

International Patent Application Publication No. WO 2007/079132 A2 discloses a system and method for providing reverse mortgage-related lending.

International Patent Application Publication No. WO 2007/047897 A2 discloses a method for providing deferred life insurance through a life insurance option.

A need in the financial industry currently exists for systems and methods for minimizing the risk of invested capital in high risk/high return investments.

### SUMMARY OF THE INVENTION

The present invention advantageously provides systems and methods for investing that minimize the risk of invested capital in high risk/high return investments.

Very advantageously, the present invention provides unique systems and methods for investors to invest in a new start-up or potential high growth (or other) company, and potentially make a substantial return on their investment, while minimizing the risk of a loss of invested capital (i.e., having a maximized risk/investment return ratio), using a unique combination of investment vehicles and insurance products, including in force non-variable (or other) life insurance policies held on individuals most preferably ranging in age from about 70 to about 80 years (Insureds), Single Premium Immediate Annuities, and LIBAC^{SM} distributions, to provide the assurance of return of invested capital. Additionally, these methods may advantageously generate assets and revenue that may help a new start-up or potential high growth company to “go public.” The systems and methods of the invention may be used independent of a personal computer, or may be carried out using a personal computer, with or without an Internet connection.

The systems and methods of the present invention provide a low risk return of invested capital through an acquisition of death benefits in an asset that is equal to, or in excess of, the total amount of the funds invested, a method for assuring the payment of life insurance policy premiums, administrative expenses, and taxes that are incidental to such methods, while a majority of the invested funds go to the business enterprise that presents a potential high rate of return on invested capital.

The LIBAC^{SM} business system and LIBAC^{SM} business process of the invention advantageously are effective financing tools for Issuers requiring financing that is not available in the current (or other) marketplace, and were designed to advantageously provide a much needed collateral instrument for Issuers to gain access to financing, where financing may not otherwise be available.

In one aspect, the present invention provides an investment system that permits one or more investors to invest in a business entity, with potential returns on their investment while minimizing a risk of a loss of invested capital, comprising:
(a) one or more in force life insurance policies provided by one or more Insureds ranging from about 65 to about 85 years in age that insure the lives of the Insureds, or their spouses, and that have one or more beneficiaries, wherein the beneficiaries are persons who, on the date of an issuance of the life insurance policies, have an insurable interest in the lives of the Insureds or their spouses;
(b) an instrument governing a formation, or provision, of a Pass Through Business Entity, preferably formed by an Issuer;
(c) an Offering Memorandum for a securities Offering in which the following are offered for sale to one or more Investors in exchange for a payment by the Investors of investment funds:
   (1) by the Pass Through Business Entity of ownership interests in the Pass Through Business Entity, wherein a portion of the total investment funds invested by the Investors is paid to the Pass Through Business Entity for such ownership interests, and wherein such portion is an amount that is required to acquire one or more LIBAC^{SM} Assets having a combined face value that is similar to, equal to, or in excess of, the total amount of the invested funds; and
   (2) by the Issuer, one or more classes of “equity interests,” “debt securities,” or a combination of “equity interests” and “debt securities,” wherein a portion of the total investment funds invested by the Investors is paid to the Issuer for such “equity interests,” “debt securities,” or combination of “equity interests” and “debt securities,” and wherein such portion is a remaining net balance of the total investment funds paid by the Investors;
(d) an agreement in which the Insureds agree to:
   (1) sell their interests in the LIBAC^{SM} Assets; and
   (2) use a portion of funds provided to them by the Pass Through Business Entity to purchase one or more Single Premium Immediate Annuities, wherein each Insured is the measuring life of the annuity(ies) such Insured purchases and is sole annuitant of the annuity(ies) and the beneficiary of the annuity(ies), or each Insured is the measuring life of the annuity(ies) and one or more other entities to be acquired by the Pass Through Business Entity are the beneficiary(ies), wherein the Single Premium Immediate Annuities generate one or more annuity payments in amounts that are sufficient to pay:
      (i) premiums that become due for the life insurance policies,
      (ii) administrative expenses; and/or
      (iii) incidental taxes related to Single Premium Immediate Annuity income;
and wherein the Single Premium Immediate Annuities terminate upon the deaths of the Insureds, or at the related life insurance policy maturity date if earlier than the death of the Insured whose life is the measuring life for both the life insurance policy and the related Single Premium Immediate Annuity;
(e) one or more Single Premium Immediate Annuities, wherein such annuities are purchased using funds advanced to the Insureds by the Pass Through Business Entity;
(f) LIBAC^{SM} distributions comprising:
   (1) death benefits under the life insurance policies, wherein the life insurance policies have a total (combined) face value that is similar to, equal to, or in excess of, the total amount of funds invested by the Investors in the securities Offering; and
   (2) annuity payments made under the one or more Single Premium Immediate Annuities that are similar to, equal to, or in excess of, the amount of money that is required to pay:
      (i) premiums due for the life insurance policies;
      (ii) administrative expenses; and/or
      (iii) taxes due on the income portion of Single Premium Immediate Annuity payments;
wherein the LIBAC^{SM} distributions are provided to the Pass Through Business Entity, and provide funds for distribution to each Investor for a repayment of a portion, up to all, of the principal amount of the Investor's investment made pursuant to the Offering, and wherein the Issuer, upon achieving one or more pre-specified Investment Milestones in connection with the “equity interests,” “debt securities,” or combination of “equity interests” and “debt securities” may, optionally:
   (i) be entitled to collect a portion of the LIBAC^{SM} distributions, such that it may book an aliquot interest in the Pass Through Business Entity as an asset on a balance sheet; and
   (ii) upon the deaths of one or more of the Insureds, be provided with a portion or all of the death benefits provided by the life insurance policies.

In another aspect, the present invention provides an investment system that permits one or more investors to invest in a business entity, with potential returns on their investment while minimizing a risk of a loss of invested capital, comprising:
(a) one or more Revocable Life Insurance Trusts provided by one or more Insureds ranging from about 65 to about 85 years in age for which the Insureds, or their spouses, are the Grantor(s), wherein the Revocable Life Insurance Trusts contain one or more in force, non-variable or other life insurance policies that insure the lives of the Insureds, or of their spouses, and that have one or more beneficiaries, and wherein the beneficiaries of the Revocable Life Insurance Trusts are individuals who, on the date of the issuance of the non-variable life insurance policies, have or had an insurable interest in the lives of the Insureds, or their spouses;
(b) an instrument governing a formation, or provision, of a Pass Through Business Entity, preferably by an Issuer;
(c) a Master Life Insurance Trust preferably formed by the Pass Through Business Entity, wherein this trust is funded by the Pass Through Business Entity, optionally using a minority portion of the total funds invested by the Investors;
(d) an Offering Memorandum governing a public or private securities Offering in which the following are offered for sale to one or more Investors in exchange for a payment by the Investors of investment funds:
   (1) by the Pass Through Business Entity of new-issue “membership interests” in the Pass Through Business Entity, wherein the portion of the total investment funds invested by the Investors is paid to the Pass Through Business Entity for such “membership interests,” and wherein such portion, optionally, is a minority of the total investment funds paid by the Investors, and is an amount required to acquire one or more LIBAC^{SM} Assets having a face value similar to, equal to, or in excess of, the total amount of the invested funds; and
   (2) by the Issuer of one or more classes of “equity interests,” “debt securities,” or a combination of “equity interests” and “debt securities,” wherein a portion of the total investment funds invested by the Investors is paid to the Issuer for such “equity interests,” “debt securities,” or combination of “equity interests” and “debt securities,” is, optionally, a majority and remaining net balance of the total investment funds paid by the Investors;
(e) an agreement in which the Insureds of the Revocable Life Insurance Trusts agree to:
   (1) sell their trust powers; and
   (2) use a portion of the funds provided to them by the Master Life Insurance Trust to cause the Revocable Life Insurance Trust to purchase one or more Single Premium Immediate Annuities whose measuring life is the same measuring life as the life insured under the life insurance policy(ies) owned by the Revocable Life Insurance Trust;
(f) one or more Single Premium Immediate Annuities, wherein each Insured is the measuring life of the related annuity(ies), and the beneficiaries of the annuities are the Revocable Life Insurance Trusts, wherein the Single Premium Immediate Annuities generate one or more annuity payments in amounts that are sufficient to pay:
   (i) premiums that become due for the life insurance policies,
   (ii) the fees for the trustee(s) of the Revocable Life Insurance Trusts and Master Life Insurance Trust;
   (iii) Pass Through Business Entity administrative expenses; and/or
   (iv) any income tax that becomes due on that portion of proceeds of the annuity that are taxable;
wherein the Single Premium Immediate Annuities terminate upon the death of the Insureds, or at the related life insurance policy maturity date if earlier than the death of the Insured;
(g) an instrument in which the Master Life Insurance Trust acquires trust powers to control one or more Revocable Life Insurance Trusts, and have the grantor Master Life Insurance Trust named as a beneficiary of the Revocable Life Insurance Trusts and, thereby, obtain a right to receive LIBAC^{SM} distributions;
(h) LIBAC^{SM} distributions comprising:
   (1) death benefits under the life insurance policies owned by each Revocable Life Insurance Trust, wherein the life insurance policies have a total (combined) face value that is similar to, equal to, or in excess of, the total amount of funds invested by the Investors in the Offering; and
   (2) annuity payments made under one or more Single Premium Immediate Annuities (each a “SPIA”) that are similar to, equal to, or in excess of, the amount of money that is required to pay:
      (i) premiums due for the life insurance policies;
      (ii) trust administrative expenses;
      (iii) Pass Through Business Entity administrative expenses;
      (iv) taxes due on the income portion of Single Premium Immediate Annuity payments; or
      (v) a combination of any two or more of (i), (ii), (iii) and (iv);
wherein the LIBAC^{SM} distributions provide funds for distribution to each Investor for a repayment of a portion, up to all, of the principal amount of the Investor's investment made pursuant to the Offering, and wherein the Issuer may, optionally, be entitled to collect a portion of the LIBAC^{SM} distributions, depending upon the Issuer achieving one or more pre-specified Investment Milestones in connection with the “equity interests,” “debt securities,” or a combination thereof, issued by the Issuer as part of the Offering;
(i) an instrument in which the grantors of the Revocable Life Insurance Trusts are assigned all rights to amend, change and/or revoke the Revocable Life Insurance Trusts, and all rights and powers to sell, convey, transfer and/or assign trust powers to the Master Life Insurance Trust, through which the written agreements governing the Revocable Life Insurance Trusts are amended to:
   (1) optionally, name the Master Life Insurance Trust as the sole beneficiary of the Revocable Life Insurance Trusts;
   (2) optionally, name a new trustee(s) of the Revocable Life Insurance Trusts, wherein the new trustee(s) are designated by the Master Life Insurance Trust;
   (3) provide that the beneficiary has the power to amend, change and/or revoke the Revocable Life Insurance Trust in the future; and
   (4) provide that the beneficiary has the right and power to sell, convey, transfer and/or assign trust powers in the future;
(j) an instrument in which the Insureds assign all of their rights and powers to amend, change, revoke and/or supplement trust agreements that govern the Revocable Life Insurance Trusts, and the right and power to sell, convey, transfer and/or assign trust powers, in exchange for a payment to the Insureds by the Master Life Insurance Trust, wherein the payment is made using funds provided to it by the Pass Through Business Entity;
(k) an instrument, for example, a Revocable Trust Powers Assignment contract, providing that the Master Life Insurance Trust advance funds to the grantor(s) of the Revocable Life Insurance Trusts for the purchase of one or more Single Premium Immediate Annuities whose measuring life is the same measuring life as the life insured under the life insurance policy(ies) owned by the Revocable Life Insurance Trust (pursuant to the terms of the instrument);
(l) optionally, an instrument providing that, upon achieving one or more pre-specified Investment Milestones, the Issuer is to be provided, upon the deaths of the Insureds, a portion of the death benefits provided by the life insurance policies, and that any LIBAC^{SM} distributions, or portions thereof, optionally may be retained by the Pass Through Business Entity for the time period within which such Investment Milestones must be reached, or may be distributed wholly or partially to Investors until the Issuer reaches one or more Investment Milestones, at which point the Issuer may be entitled to a portion or all of such distributions;
(m) an instrument providing that, upon the deaths of the Insureds, all or a remaining portion of the death benefits provided by the life insurance policies will be paid to the Investors, and that the Investors will be provided at least with a full return of their principal investment and, optionally, with an additional return on their principal investment; and
(n) optionally, an instrument providing that, the Issuer may receive a right to share in LIBAC^{SM} distributions upon reaching its pre-specified Investment Milestones, such that upon reaching such Investment Milestones, it may book its aliquot interest in the Pass Through Business Entity as an asset on its balance sheet.

In another aspect, the present invention provides a method for one or more investors to invest in a business entity, with potential returns on their investment while minimizing a risk of a loss of invested capital comprising the following steps (in any reasonable order):
(a) providing by one or more Insureds ranging from about 65 to about 85 years in age one or more in force life insurance policies that insure the lives of the Insureds, or of the Insureds' spouses, that preferably have an expired contestability period, and that have one or more beneficiaries, wherein the beneficiaries are persons who, on the date of the issuance of the life insurance policies, have an insurable interest in the lives of the Insureds, or their spouses;
(b) forming, or providing, a Pass Through Business Entity, preferably by an Issuer;
(c) in a securities Offering, offering for sale to one or more Investors in exchange for a payment by the Investors of investment funds:
   (1) by the Pass Through Business Entity of ownership interests in the Pass Through Business Entity, wherein a portion of the total investment funds invested by the Investors is paid to the Pass Through Business Entity for such ownership interests, and wherein such portion is an amount that is required to acquire one or more LIBAC^{SM} Assets having a combined face value that is similar to, equal to, or in excess of, the total amount of the invested funds; and
   (2) by the Issuer, one or more classes of “equity interests” and/or “debt securities” (new issue or already issued), wherein a portion of the total investment funds invested by the Investors is paid to the Issuer for such “equity interests” and/or “debt securities,” and wherein such portion is a remaining net balance of the total investment funds paid by the Investors;
(d) causing the Insureds to enter into a contract agreeing to sell their interest in the LIBAC^{SM} Assets and obligating them to use a portion of funds provided to them by the Pass Through Business Entity to purchase one or more Single Premium Immediate Annuities, wherein each Insured is the measuring life of the annuity(ies) such Insured purchases and is sole annuitant of the annuity(ies) and the beneficiary of the annuity(ies), or each Insured is the measuring life of the annuity(ies) and one or more other entities to be acquired by the Pass Through Investment Entity (generally according to a contract) are the beneficiary(ies), wherein the Single Premium Immediate Annuities generate one or more annuity payments in amounts that are sufficient to pay:
   (i) premiums that become due for the life insurance policies;
   (ii) administrative expenses; and/or
   (iii) incidental taxes related to Single Premium Immediate Annuity income;
and wherein the Single Premium Immediate Annuities terminate upon the deaths of the Insureds, or possibly at the related life insurance policy maturity date if earlier than the death of the Insured whose life is the measuring life for both the life insurance policy and the related Single Premium Immediate Annuity;
(e) advancing funds to the Insureds by the Pass Through Business Entity for the purchase of one or more Single Premium Immediate Annuities;
(f) providing LIBAC^{SM} distributions to the Pass Through Business Entity comprising:
   (1) death benefits under the life insurance policies, wherein the life insurance policies have a total (combined) face value that is similar to, equal to, or in excess of, the total amount of funds invested by the Investors in the Offering; and
   (2) annuity payments made under the one or more Single Premium Immediate Annuities that are similar to, equal to, or in excess of, the amount of money that is required to pay:
      (i) premiums due for the life insurance policies;
      (ii) administrative expenses; and/or
      (iii) taxes due on the income portion of Single Premium Immediate Annuity payments;
wherein the LIBAC^{SM} distributions are provided to the Pass Through Business Entity, and provide funds for distribution to each Investor for a repayment of a portion, up to all, of the principal amount of the Investor's investment made pursuant to the Offering, and wherein the Issuer, upon achieving one or more pre-specified Investment Milestones in connection with the “equity interests,” “debt securities,” or combination of “equity interests” and “debt securities” may, optionally:
   (i) be entitled to collect a portion of the LIBAC^{SM} distributions, such that it may book an aliquot interest in the Pass Through Business Entity as an asset on a balance sheet; and
   (ii) upon the deaths of one or more of the Insureds, be provided with a portion, up to all, of the death benefits provided by the life insurance policies;
wherein any LIBAC^{SM} distributions from such death benefits, or portions thereof may be retained by the Pass Through Business Entity for the time period within which such Investment Milestones must be reached, or may be distributed wholly or partially to Investors until the Issuer reaches one or more Investment Milestones, at which point the Issuer may be entitled to a portion, up to all, of such distributions.

In another aspect, the present invention provides a method for one or more investors to invest in a business entity, with potential returns on their investment while minimizing a risk of a loss of invested capital comprising the following steps (in any reasonable order):
(a) providing by one or more Insureds ranging from about 65 to about 85 years in age one or more Revocable Life Insurance Trusts, for which the Insured or the Insured's spouse is the Grantor, containing one or more in force, non-variable (or other) life insurance policies that insure the lives of the Insureds, or of their spouses, that preferably have an expired contestability period, and that have one or more beneficiaries, wherein the Revocable Life Insurance Trusts are preferably governed by trust agreements executed by the Insureds and/or the Insureds' spouses, wherein the Revocable Life Insurance Trusts are preferably the sole owners and sole beneficiaries of the non-variable life insurance policies, and wherein the beneficiaries of the Revocable Life Insurance Trusts are individuals who, on the date of the issuance of the non-variable life insurance policies, have or had an insurable interest in the lives of the Insureds or their spouses;
(b) forming or providing, preferably by an Issuer, a Pass Through Business Entity, wherein preferably a there is a sole manager of the Pass Through Business Entity (who may or may not have an equity interest in the Pass Through Business Entity) who is preferably designated by the patent holder;
(c) forming, preferably by the Pass Through Business Entity (as grantor), of a Master Life Insurance Trust, wherein the Pass Through Business Entity funds this trust using, preferably, a minority portion of the total funds invested by the Investors, and wherein the Pass Through Business Entity is preferably a sole beneficiary of this trust;
(d) in a public or private securities Offering, offering for sale to one or more Investors in exchange for a payment by the Investors of investment funds:
   (1) by the Pass Through Business Entity of new-issue “membership interests” in the Pass Through Business Entity, wherein the portion of the total investment funds paid to the Pass Through Business Entity by the Investors for such “membership interests” is, preferably, a minority of the total investment funds paid by the Investors, and is an amount required to acquire one or more LIBAC^{SM} Assets having a face value similar to, equal to, or in excess of, the total amount of the invested funds, wherein the Investors preferably become the sole non-manager equity members of the Pass Through Business Entity; and
   (2) of one or more classes of “equity interests” and/or “debt securities” of the Issuer, wherein the portion of the total investment funds paid to the Issuer by the Investors for such “equity interests” and/or “debt securities” is, preferably, a majority and remaining net balance of the total investment funds paid by the Investors;
(e) causing the Insureds of the Revocable Life Insurance Trusts to enter into a contract (the “Revocable Trust Powers Assignment” contract) to sell their trust powers and obligate them to use a portion of the funds provided to them by the Master Life Insurance Trust (which may or may not be irrevocable, but which, upon formation, has elected to be treated as a partnership for tax reporting purposes) to cause the Revocable Life Insurance Trust to purchase one or more Single Premium Immediate Annuities, wherein each Insured is the measuring life of the related annuity(ies), and the beneficiaries (preferably the sole beneficiary) of the annuities are the Revocable Life Insurance Trusts, wherein the Single Premium Immediate Annuities generate one or more annuity payments in amounts that are sufficient to pay the premiums that become due for the non-variable life insurance policies, the fees of the trustee(s) of the Revocable Life Insurance Trusts, the fees of the trustee(s) of the Master Life Insurance Trust, Pass Through Business Entity administrative expenses and/or any income tax that becomes due on that portion of proceeds of the annuity that are taxable, and wherein the Single Premium Immediate Annuities terminate upon the death of the Insureds, or possibly at the related life insurance policy maturity date if earlier than the death of the insured because the Insured's life is the measuring life for both the policy and the related Single Premium Immediate Annuity;
(f) acquiring, by the Master Life Insurance Trust, trust powers to control one or more Revocable Life Insurance Trusts and having the grantor Master Life Insurance Trust named as a beneficiary (preferably the sole beneficiary) of the Revocable Life Insurance Trusts and, thereby, obtain a right to receive LIBAC^{SM} distributions comprising:
   (1) death benefits under the non-variable life insurance policies owned by each Revocable Life Insurance Trust, wherein the non-variable life insurance policies have a total (combined) face value that is similar to, equal to, or in excess of, the total amount of funds invested by the investors in the offering; and
   (2) annuity payments made under one or more Single Premium Immediate Annuities (each a “SPIA”) that are similar to, equal to, or in excess of, the amount of money that is required to pay:
      (i) premiums due for the non-variable life insurance policies;
      (ii) trust administrative expenses;
      (iii) Pass Through Business Entity administrative expenses; and/or
      (iv) taxes due on the income portion of Single Premium Immediate Annuity payments;
wherein the LIBAC^{SM} distributions provide funds for distribution to each Investor for a repayment of a portion, up to all, of the principal amount of the Investor's investment made pursuant to the Offering, and wherein the Issuer may, optionally, be entitled to collect a portion of the LIBAC^{SM} distributions, depending upon the Issuer achieving one or more pre-specified Investment Milestones in connection with the “equity interests” and/or “debt securities” issued by the Issuer as part of the Offering;
(g) assigning by the grantors of the Revocable Life Insurance Trusts all rights to amend, change and/or revoke the Revocable Life Insurance Trusts and all rights and powers to sell, convey, transfer and/or assign trust powers to the Master Life Insurance Trust through which the written agreements governing the Revocable Life Insurance Trusts are amended to (among other things):
   (1) name the Master Life Insurance Trust, preferably, as the sole beneficiary of the Revocable Life Insurance Trusts;
   (2) optionally, name a new trustee(s) of the Revocable Life Insurance Trusts, wherein the new trustee(s) are designated by the Master Life Insurance Trust;
   (3) provide that the beneficiary has the power to amend, change and/or revoke the Revocable Life Insurance Trust in the future; and
   (4) provide that the beneficiary has the right and power to sell, convey, transfer and/or assign trust powers in the future;
(h) using funds provided to it by the Pass Through Business Entity for the payment of such funds to the Insureds by the Master Life Insurance Trust in exchange for an assignment of all of the rights and powers of the Insureds to amend, change, revoke and/or supplement the trust agreements that govern the Revocable Life Insurance Trusts and the right and power to sell, convey, transfer and/or assign trust powers;
(i) advancing funds, by the Master Life Insurance Trust, to the grantor(s) of the Revocable Life Insurance Trusts for the purchase of one or more Single Premium Immediate Annuities pursuant to the terms of the Revocable Trust Powers Assignment contract;
(j) optionally, upon achieving one or more pre-specified Investment Milestones (preferably set forth in a Pass Through Business Entity Operating Agreement and the Offering document), providing to the Issuer upon the deaths of the Insureds a portion of the death benefits provided by the in force non-variable life insurance policies, wherein such portion is preferably described in a Pass Through Business Entity Operating Agreement and the Offering document, and wherein any LIBAC^{SM} distributions, or portions thereof, optionally may be retained by the Pass Through Business Entity for the time period within which such Investment Milestones must be reached or may be distributed wholly or partially to Investors until the Issuer reaches one or more Investment Milestones, at which point the Issuer may be entitled to a portion, up to all, of such distributions;
(k) providing to the Investors upon the deaths of the Insureds all or a remaining portion of the death benefits provided by the in force non-variable life insurance policies, wherein the Investors are provided at least with a partial, and preferably a full, return of their principal investment and, optionally, with an additional return on their principal investment; and
(l) optionally, providing to the Issuer a right to share in LIBAC^{SM} distributions upon reaching its Investment Milestones, such that upon reaching such Investment Milestones, it may book its aliquot interest in the Pass Through Business Entity as an asset on its balance sheet.

Under one embodiment of the systems and methods of the invention, Investors receive the death benefits as each life insurance policy matures. Under another embodiment, the Pass Through Business Entity (Limited Liability Company or other entity) retains the death benefits for a predetermined period of time, as is preferably set forth in a Pass Through Business Entity Operating Agreement (or other governing document or agreement), to determine whether or not the Issuer has met its Investment Milestone(s), so as to be entitled to some portion of the death benefits. Under still another embodiment, Investors receive all death benefits and the Issuer only shares in distributions upon meeting its Investment Milestone(s).

The systems and methods that are described herein may be computer implemented methods, or may be performed in the absence of a computer.

### BRIEF DESCRIPTION OF THE DRAWINGS

FIG. 1 is a flow chart that illustrates a preferred embodiment of the systems and methods of the present invention.

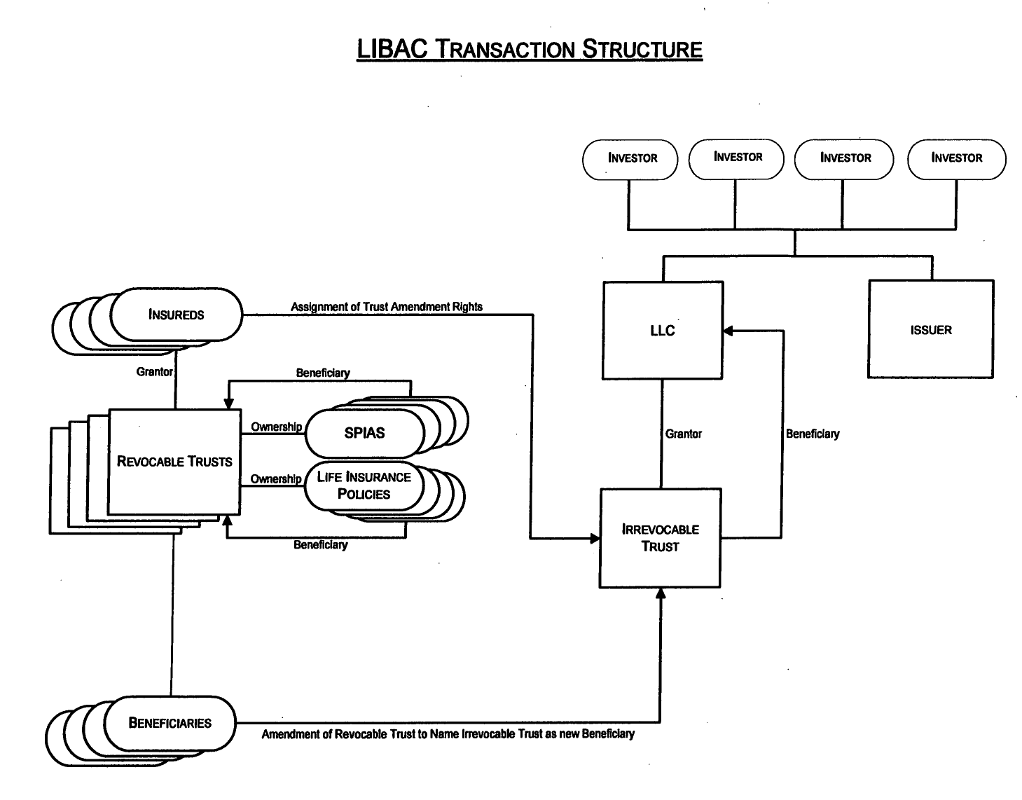

### DETAILED DESCRIPTION OF THE PREFERRED EMBODIMENTS

The present invention may be understood more readily by reference to the following detailed description of the preferred embodiments of the invention, and to the examples included therein.

Definitions

For purposes of clarity, various terms and phrases used throughout this specification and the appended claims are defined in the manner set forth below. If a term or phrase used in this specification, or in the appended claims, is not defined below, or otherwise in this specification, the term or phrase should be given its ordinary meaning.

The phrase “Accredited Investor” as is used herein is as defined in Rule 501 of Regulation D, promulgated under Section 4(2) of the Securities Act of 1933, as amended, and generally includes:
a bank, insurance company, registered investment company, business development company, or small business investment company;
an employee benefit plan, within the meaning of the Employee Retirement Income Security Act, if a bank, insurance company, or registered investment adviser makes the investment decisions, or if the plan has total assets in excess of $5 million;
a charitable organization, corporation, or partnership with assets exceeding $5 million;
a director, executive officer, or general partner of the company selling the securities;
a business in which all the equity owners are accredited investors;
a natural person who has individual net worth, or joint net worth with the person's spouse, that exceeds $1 million at the time of the purchase;
a natural person with income exceeding $200,000 in each of the two most recent years, or joint income with a spouse exceeding $300,000 for those years, and a reasonable expectation of the same income level in the current year; or
a trust with assets in excess of $5 million, not formed to acquire the securities offered, whose purchases a sophisticated person makes.

The phrases “all or none” or “all or none basis” as are used herein mean an order type for a broker (or similar individual or entity) to execute a trade only if every share of an order can be filled in its entirety, or else not at all.

The term “annuity” as is used herein means a contract sold by an insurance or other company that is designed to provide a series of payments to the holder of the annuity at specified intervals. Annuities are sometimes described as the opposite of life insurance because annuities can help an individual protect against the possibility of living too long and outliving the individual's resources. Annuity contracts typically pay level periodic payments as long as the annuitant is alive. An owner of an annuity can designate an annuity payee whereby the annuity payee will receive periodic payments until the death of the life measured by the annuity contract. The holder of the annuity is typically taxed only when the holder starts taking distributions or withdraws funds from the account. All annuities are typically tax-deferred, meaning that the earnings from investments in these accounts grow tax-deferred until withdrawal. Fixed annuities generally guarantee a certain payment amount, while variable annuities do not, but have the potential for greater returns. Both are considered to be a relatively safe, low-yielding type of an investment. Annuities generally have a death benefit equivalent to the higher of the current value of the annuity or the amount the buyer has paid into it. If the owner dies during the accumulation phase, his or her heirs will generally receive the accumulated amount in the annuity. This money is typically subject to ordinary income taxes in addition to estate taxes.

The phrase “asset” as is used herein means any item of economic value owned by an individual or entity, particularly that which can be converted to cash. Examples are cash, securities, accounts receivable, inventory, office equipment, real estate, personal property, intellectual property and other property.

The phrase “basis” as is used herein in connection with a security generally means the total amount invested (i.e., the purchase price).

The term “beneficiary” as is used herein means an individual or entity that receives, or may become eligible to receive, benefits under an insurance policy, an annuity, a trust, an agreement, escrow, or the like, or any combination thereof.

The phrases “best efforts” and “best efforts basis” as are used herein mean either: (i) an agreement by an investment banker (or other investor) to do its best to oversee, but not guarantee, the sale of a security issue; or (ii) an investor's market order to buy or sell a security in which the brokerage (or other) firm agrees to obtain the best possible price.

The phrase “business entity” as is used herein means an entity that is a group of people organized for some profitable or charitable purpose, and includes organizations such as corporations, partnerships, charities, trusts, and other forms of organization.

The term “capital” as is used herein means cash or goods that are generally used to generate income either by investing in a business or an income property.

The phrase “closed-end fund” as is used herein means a collective investment scheme with a limited number of shares.

The term “collateral” as is used herein means asset(s) generally pledged by a borrower to secure a loan or other credit, and subject to seizure in the event of a default.

The phrase “Company” as is used herein means, depending upon the context of use: (i) any entity engaging in business, such as a proprietorship, a partnership, a limited liability company or a corporation; or (ii) a business entity formed to acquire LIBAC^{SM} Assets for the benefit of Investors who are equity holders in the company, such as a Pass Through Business Entity (Limited Liability Company and/or the like).

The phrase “common stock” as is used herein means securities representing equity ownership in a corporation, which usually includes voting rights, and entitling the holder to a share of the company's success through dividends and/or capital appreciation. In the event of liquidation, common stockholders generally have rights to a company's assets only after bondholders, other debt holders, creditors and preferred stockholders have been satisfied.

The phrase “contestability period” as is used herein means a period of time after the issuance of an insurance policy by an insurer to an Insured during which the insurer has a legal right to contest a claim made in connection with the insurance policy, for example, on the basis of misrepresentation by the Insured, suicide by the Insured or the like, and request additional information before deciding whether to pay or deny the claim. Contestability periods in connection with life insurance policies are typically two years.

The phrase “deal points” as is used herein means the terms under which an Issuer agrees to sell its securities.

The phrase “death benefit” as is used herein means a payment (usually in a lump sum) that is made to a beneficiary in connection with a life insurance policy, an annuity and/or some other investment vehicle when a policyholder dies, or at the expiration of some fixed period of time. Factors that may influence a determination of a death benefit by an insurer include the age of the Insured, assets (including cash) that are directed into a premium fund and the desired return of investment for the insurer (or other financier).

The term “debenture” as is used herein means an unsecured debt that generally is backed only by the integrity of the borrower, rather than by collateral, and is generally documented by an agreement (an indenture). Examples include unsecured notes or bonds.

The term “debt” as is used herein means an amount of money or assets owed to a person or entity for funds borrowed. Debt may be represented by a loan note, a bond, a mortgage or other form stating repayment terms and, if applicable, interest requirements. These different forms all imply intent to pay back an amount owed by a specific date, which is generally set forth in the repayment terms.

The phrase “debt security” as is used herein means a security representing a loan given by an Investor to an Issuer. In return for the loan, the Issuer generally promises to pay interest and to repay the debt on a specified date.

The phrases “Delaware Statutory Trust” and “DST” as are used herein mean a separate legal entity created as a trust under Delaware statutory law. Delaware law permits a flexible approach to the design and operation of this entity. This entity is discussed in detail in Arnold S. Harrison, Esq., “Bank and Lender Liability,” West Andrews Litigation Reporter, Volume 12, Issue 1 (2006), which is hereby incorporated herein by reference in its entirety.

The term “entity” as is used herein means a new or existing corporation, company, Limited Liability Company, limited partnership, proprietorship, financial or other institution or organization or other form of business, or non-profit, or other associated or unassociated group of people.

The phrases “equity” and “equity interest” as are used herein mean an ownership interest (partial or total ownership) in an asset, a corporation, a partnership or an other entity, for example, in the form of common stock or preferred stock, or in the form of membership interest in a Limited Liability Company (LLC), other Pass Through Business Entity, or other entity.

The phrase “face value” as is used herein means the value that is generally printed or written on the face of a document or instrument, such as a bond. In connection with a life insurance policy, it generally is the death benefit.

The phrases “Financial Industry Regulatory Authority, Inc.” and “FINRA” as are used herein refer to the largest self-regulatory organization (SRO) in the United States, which writes and enforces rules governing the securities industry, as well as enforcing federal securities laws. FINRA has jurisdiction over all broker-dealers and registered representatives, and has authority to discipline firms and individuals who violate the rules. It regulates trading in stocks, mutual funds, variable annuities, corporate bonds, and futures and options contracts on securities. It also acts as the SRO for a number of securities exchanges, and reviews materials that investment companies provide to their clients and prospective clients to ensure that those materials comply with the relevant guidelines. FINRA also resolves disputes between broker-dealers and their clients, through either mediation or arbitration.

The phrases “fully funded” and “Fully Funded” as are used herein mean that an obligation to make future payments to preserve an asset is fulfilled by the obligation of a third party, preferably a highly rated insurance or annuity company, to provide funds expected to meet the future obligations.

The term “funds” as is used herein means money, cash, currency and/or the like.

The abbreviation “FUND” as is used herein in connection with a Direct Participation Program generally represents business entities whose business is to invest in businesses with operations not related to financial investments, e.g. Hedge Funds, Pension Funds, entities that qualify as an Investment Company under the Investment Company Act of 1940, and the like.

The phrase “FUND of FUNDS” as used herein means a fund that generally invests in other FUNDs as opposed to investing directly in businesses with operations not related to financial investments.

The term “grantor” as used herein means a person who makes a grant or forms a trust.

The phrase “in force” as is used herein in connection with a life insurance policy or annuity means that the life insurance policy or annuity is currently in force (i.e., that required premiums have been paid, that no lapse or cancellation has occurred and the like).

The terms “Initial Public Offering” and “IPO” as are used herein mean the first sale of stock by a private company to the public. IPOs are often issued by smaller, younger companies seeking capital to expand, but can also be done by large privately-owned companies looking to become publicly traded. In an IPO, the Issuer generally obtains the assistance of an underwriting firm, which helps it determine what type of security to issue (usually common or preferred), best offering price and time to bring it to market.

The terms “instrument” and “financial instrument” as are used herein mean a formal and/or legal document, such as a deed, a bond, a policy, a memorandum, a promissory note, an operating, repurchase or other agreement, an assignment, a governing document and/or the like.

The term “insurance” as is used herein means a promise of compensation for specific potential future losses in exchange for a periodic payment. Insurance is designed to protect the financial well-being of an individual or entity in the case of an unexpected loss. Agreeing to the terms of an insurance policy creates a contract between the Insured and the Insurer. In exchange for payments from the Insured (premiums), the insurer agrees to pay the insurance policy holder or beneficiary (usually the purchaser and owner) a sum of money upon the occurrence of a specific event, such as the death of the Insured. In many cases, the policy holder pays part of the loss (deductible), and the Insurer pays the rest.

The phrase “insurance policy” as is used herein means a contract of insurance that typically describes the term, coverage, premiums and deductibles.

The phrase “Insured” as is used herein means the person or group upon whose life an insurance policy is issued.

The term “invest” as is used herein means to commit (money or capital) in order to gain a financial return.

The term “investment” as is used herein means a purchase of assets, rights or the like with an expectation that they will increase in value and/or otherwise provide a profit at some future point in time.

The phrase “investment funds” as is used herein means money, or other thing of value, that is invested with an expectation of profit.

The phrase “Investment Milestone” as is used herein generally refers to a particular mechanism that is to be used to measure, and cause a transfer of equity interests in the Pass Through Business Entity (or other entity) owning or controlling LIBAC^{SM} Assets to the Issuer, which may vary widely, and may readily be determined by those of ordinary skill in the art. Such mechanisms are typically pre-specified and set forth in a Governing or Operating Agreement, an Offering Memorandum and/or a similar document.

The term “Investor” as is used herein means a person or entity that makes an investment.

The phrase “invested funds” as is used herein means funds (money, currency and/or the like) that are paid by one or more investors to acquire assets, usually as used herein securities in the Issuer and in the Pass Through Business Entity.

The phrase “investment vehicle” as is used herein includes all existing and future types of Pass Through Investment Entities, the securities of whom may be issued to Investors by, or through, various means, including without limitation a private placement, a public offering, or a private investment in a public entity (PIPEs).

The terms “Issuer” and “issuer” as are used herein means a business (or other) entity that issues to Investors a security.

The phrase “irrevocable trust” as is used herein means a trust that cannot be changed or canceled once it is set up without the consent of the beneficiary. Contributions cannot be taken out of the trust by the grantor. Irrevocable trusts generally offer tax advantages that revocable trusts do not, for example, by enabling a person to give money and assets away even before he/she dies.

The phrase “irrevocable life insurance trust” as is used herein means a life insurance trust in which the grantor retains no ownership or control over the assets in the trust. Typically, these trusts are funded during life with a gift(s) of: (i) life insurance policies; or (ii) cash used to acquire or maintain insurance.

The term “LIBAC^{SM}” as is used herein means Life Insurance Backed Collateral.

The phrase “LIBAC^{SM} Agreement” as is used herein means a written agreement between a Master Life Insurance Trust (or another trust or Pass Through Business Entity) and an Insured governing:
(i) a Revocable Trust Powers Assignment (or similar contract or document); and/or
(ii) a purchase of one or more life insurance policies, for example, an in force, non-variable life insurance policy and one or more Single Premium Immediate Annuities.

The phrase “LIBAC^{SM} Assets” as is used herein means:
(i) one or more life insurance policies, for example, an in force, non-variable life insurance policy; and/or
(ii) one or more annuities, for example, a Single Premium Immediate Annuity for which the measuring life of the policy and the related annuity is the Insured.
   LIBAC^{SM} Assets are generally purchased by a Pass Through Business Entity, such as a Limited Liability Company, and generally function to protect investment principal.

The term “LIBAC^{SM} LLC” as is used herein means a Limited Liability Company (LLC), or other form of Pass Through Investment Vehicle, usually formed by the Issuer, that will own LIBAC^{SM} Assets.

The phrases “LIBAC^{SM} distributions” and “LIBAC^{SM} payments” as are used herein mean payments of:
(i) death benefits under one or multiple in force, non-variable (or other), and preferably non-contestable, life insurance policies, preferably with a total face value similar to, equal to, or in excess of, the total amount of funds raised in an Offering (as is described herein); and
(ii) the portion of annuity payments made under one or more Single Premium Immediate Annuities (SPIAs) that are in excess of the funds required to pay:
   (a) premiums due for such life insurance policies;
   (b) trust and/or other administrative expenses; and/or
   (c) taxes on Single Premium Immediate Annuity income;
wherein the annuities are preferably measured by the lives of the Insureds under such life insurance policies.
   (Because a Limited Liability Company, or other Pass Through Business Entity, that may be employed in systems and methods within the present invention is a “pass through” type of an entity, the taxes on pro rata taxable net Single Premium Immediate Annuity payments are generally owed by each Investor, based upon their tax bracket. So, the Limited Liability Company, or other Pass Through Business Entity, will typically make only an quarterly distributions from Single Premium Immediate Annuity payments to Investors based on the top personal income tax bracket, excluded from the definition of “LIBAC^{SM} distributions,” such that any distributions from Single Premium Immediate Annuity payments in excess of distributions to equity members, usually the Investors, for payment of taxes on SPIA income is included as part of the definition of “LIBAC^{SM} distributions”.)

The phrase “life insurance” as used herein means insurance that guarantees a payment of a specific sum of money to a designated beneficiary, usually upon the death of the Insured, but sometimes at some other predetermined time, or to the Insured if he or she lives beyond a certain age, generally under the terms of a life insurance policy. It is a well established way for people, business entities and the like to protect against the early demise of a person. Under the Internal Revenue Code Section 101(a)(1), the death benefit proceeds received by the beneficiary are tax free. However, when the death benefits are sold or assigned for value (a life settlement), the death benefit is taxable to the extent the death benefit exceeds the purchaser's or assignee's basis in the life insurance policy. The life insurance policy may be variable or non-variable, a whole life policy, a term policy, a universal policy or the like, and typically has three distinct categories of parties which have an interest in the contract: (i) the owners; (ii) the Insureds and (iii) the beneficiaries. The owner is the party who is responsible for maintaining the policy in force by remitting premium payments to the insurance company. The Insured is the person upon whose death the policy death benefit is paid. The beneficiary is the party who receives the death benefit upon the death of the insured, and usually is the spouse or other closely related relative of the Insured. Under a typical life insurance policy, the insured individual is the holder of the policy, because (s)he has purchased the policy, and is the policy owner. However, there is no requirement that the owner, insured, or beneficiary be the same person.

The phrase “life insurance trust” as used herein means a trust which is the owner of one or more life insurance policies. Upon the death of the Insured, or policy maturity if a different date then death is used in the policy, the Trustee typically invests or distributes the insurance proceeds, usually referred to as death benefits, and administers the trust for one or more beneficiaries. A life insurance trust may be revocable or irrevocable.

The phrases “life settlement” and “life insurance settlement” as are used herein mean the sale and purchase of life insurance policies, either directly or indirectly as in the case of sale of trust powers in a revocable trust that owns a life insurance policy. For example, a financial transaction in which a life insurance policy owner possessing an unneeded or unwanted life insurance policy sells the policy (typically at fair market value) to a third party for more than the cash surrender value offered by the life insurance company. The purchaser becomes the new beneficiary of the policy at maturation, and is responsible for all subsequent premium payments.

The phrase “life settlement escrow” as is used herein means LIBAC^{SM} Assets or Trust Powers held in trust by a third party to be turned over to the Pass Through Business Entity only upon fulfillment of a condition, which is usually the payment to the owner of the LIBAC^{SM} Assets or Trust Powers and who is usually the Insured and grantor of the Revocable Life Insurance Trust.

The phrase “limited liability” as used herein means the concept whereby a person's financial liability is generally limited to a fixed sum, most commonly the value of a person's investment in a company or partnership with limited liability. For example, a member in a Limited Liability Company is not personally liable for any of the debts of the company, other than for the value of his investment in that company. The same is true for the members of a limited liability partnership and the limited partners in a limited partnership. In contrast, sole proprietors, partners in general partnerships, and general partners in limited partnerships are each generally liable for all the debts of the business (i.e., they have unlimited liability).

The phrases “Limited Liability Company” and “LLC” as used herein mean a legal form of business company (a corporation, an association, a partnership, a joint stock company, a union or other business organization or group of persons that carries on a commercial or industrial enterprise, whether incorporated or not) offering limited liability to its owners. It is similar to a corporation, and is often a more flexible form of ownership, especially suitable for smaller companies with a limited number of owners. Unlike a regular corporation, a Limited Liability Company with one member may be treated as a disregarded entity, so the member is often singled-out as a person performing the actions of the LLC. A Limited Liability Company with multiple members may choose, generally at the time that the new entity applies for a U.S. federal taxpayer ID number, to be treated for U.S. federal taxation purposes as a partnership, a C corporation or an S corporation. An LLC can typically elect to be “member managed” or “manager managed.” In the systems and methods of the present invention, the preferable election would be as a partnership that is manager managed. Limited Liability Companies are preferably governed by a Limited Liability Company Operating Agreement (or other governing agreement).

The phrases “Limited Partnership” and “LP” as used herein mean a business structure that allows one or more partners (limited partners) to enjoy limited personal liability for partnership debts while another partner or partners (general partners) have unlimited personal liability. The key difference between a general and limited partner generally concerns management decision making. Typically, general partners run the business, and limited partners, who are usually passive investors, are not allowed to make day-to-day business decisions. If they do, they risk being treated as general partners with unlimited personal liability.

The phrase “marked to market” as is used herein means that a financial instrument in question should be valued based upon the objective value provided by the marketplace. Accounting rules require some financial instruments to be valued on the owner's balance sheet based on “Marked to Market.”

The phrase “Maximum Offering” as is used herein means the largest amount of gross Offering proceeds that an Issuer may receive from the sale of its securities before it must stop offering such securities on the terms proposed in an Offering.

The phrase “Minimum Offering” as is used herein means the smallest amount of gross Offering proceeds that an Issuer must receive from the sale of its securities before such sale may be completed.

The phrases “Net Asset Value” and “NAV” as used herein mean a value used by investment companies to measure net assets. It is calculated by subtracting liabilities from the value of a fund's securities, and other items of value. NAV per share is calculated by dividing the NAV figure by the number of ordinary shares. Net asset value per share is popularly used in newspaper mutual fund tables to designate the price per share for the fund. Units in open ended funds are valued using this measure. Closed ended investment trusts have a net asset value, but have a separate market value. Investments trusts may trade at net asset value or their price may be at a premium or discount to NAV. With respect to value or purchase price of a share of stock in a mutual fund, NAV is calculated each day by taking the closing market value of all securities owned plus all other assets such as cash, subtracting all liabilities, then dividing the result (total net assets) by the total number of shares outstanding. To calculate mutual fund net asset values, the current market value of the fund's net assets (securities held by the fund minus any liabilities) is divided by the number of shares outstanding.

The phrase “non-variable life insurance” as used herein in connection with a life insurance policy means a life insurance policy that is not variable life insurance.

The term “majority” as used herein means 51% or greater.

The phrase “Master Life Insurance Trust” as is used herein means a life insurance trust, that may be revocable or irrevocable, that is formed to obtain the trust powers of one or more revocable trusts, and to be the beneficiary of the revocable trusts.

The phrase “membership interest” as is used herein means the equity interest of non-managing owners in a Limited Liability Company or other Pass Through Business Entity.

The term “minority” as is used herein means 49% or less.

The term “multiple” as is used herein means two, three, four, five, six, seven, eight, nine, ten, fifteen, twenty, twenty-five or more.

The phrase “new issue” as is used herein means newly issued, for example, a class of security that has never been issued before. In the systems and methods of the present invention, a class of security can be new issue or already issued (one that has been issued before).

The phrase “Offering” as is used herein means a stock, other equity, bond, promissory note or similar item, generally referred to singularly as a security and plurally as securities, that is offered for purchase or issuance. For example, in an initial public offering (IPO), a company's stock is made available for purchase by the public. The placement (or co-placement) of an Offering may, for example, be made through a Placement Agent, such as a FINRA Member Broker-Dealer, for example, Capital Growth Resources (El Cajon, Calif.).

The phrase “Operating Agreement” as used herein means a contract among members of a Limited Liability Company (an LLC), or other Pass Through Business Entity or entity, governing the membership, management, rights, duties, operation, capital contributions, voting rights, transfer of interest, dissolution, distribution of income of the company and/or the like. It is similar to a corporation's bylaws.

The phrase “pass through” as is used herein mean that the tax consequences of a business enterprise (a “Pass Through Investment Vehicle” or “Pass Through Business Entity”) are paid by the owners or members thereof directly, and not by the business enterprise itself. Pass Through Investment Vehicles are non-taxable entities that include, for example, Limited Liability Companies, General Partnerships, Limited Partnerships, S Corporations, Simple Trusts, Regulated Investment Companies, Real Estate Investment Trusts (REIT), Delaware Statutory Trusts who elect to be treated as partnerships, and the like. Generally, the income or expense is “passed” to the underlying owners, and retains its character as, for example, ordinary income, capital gain or Charitable Contribution. Pass Through Investment Entities, such as an S Corporation, must file a tax return, but the tax return is generally an informational return that shows how profits and losses of the entity were derived, and how much was allocated to each owner. These entities are not expected to pay taxes. In contrast, an entity that is not a Pass Through Business Entity, such as a C Corporation, must file a return and pay taxes on its taxable income and its distributions, other than salaries to shareholders, that are subject to taxation as dividends. Earnings of a C Corporation are subject to two levels of tax, one at the corporate level and one at the shareholder level. This double taxation increases the cost of its capital and services. An elimination of double taxation for Pass Through Investment Entities is an advantageous aspect of the systems and methods of the present invention. However, the systems and methods of the present invention could also be employed with entities that are not Pass Through Investment Entities, such as a C Corporation. Pass Through Investment Vehicles preferably are governed by a governing document or operating agreement, such as a Limited Liability Company Operating Agreement for a Limited Liability Company.

The phrases “Patent Holder” and “patent holder” as are used herein means an owner, licensee or assignee of one or more U.S. patents that describe and/or claim the systems and/or methods of the present invention, but does not include an Issuer, for example, the inventors, Capital Growth Resources (El Cajon, Calif.) or Capital Growth Planning, Inc. (El Cajon, Calif.).

The abbreviation “PIPE” as used herein means Private Investments in Public Entity.

The term “portfolio” as is used herein means a group of investments held by an investor, an investment company, a financial institution or a similar person or entity.

The term “portion” as is used herein in connection with the systems and methods of the invention means an amount ranging from about 0% to about 100%. Thus, the portion of the total investment funds that is paid to an Issuer, and is not allocated to the Limited Liability Company (or other Pass Through Business Entity), by one or more Investors for new issue “equity interests” and/or “debt securities” may range from about 0% to about 100%, but is preferably a majority of the total investment funds, and is usually from about 60% to about 70% after offering costs and the allocation to the Limited Liability Company. Additionally, the portion of the total investment funds that is paid to a Limited Liability Company (or other Pass Through Business Entity) by one or more Investors for “membership interests” may range from about 0% to about 100%, but is preferably a minority of the total investment funds, and is usually from about 25% to about 40%, and currently is most preferably about 38%. For example, if $10,000,000 is raised from investors in an offering, from about 0 to about $10,000,000 may be paid to the issuer for the “equity interests” or “debt securities,” and from about 0 to about $10,000,000 may be paid to the Limited Liability Company for the “membership interests,” and preferably about $3,800,000 is paid to the Limited Liability Company, from about $700,000 to about $1,000,000 is expended in Offering costs and the net of from about $5,200,000 to about $5,500,000 is received by the issue directly. As another example, if $10,000,000 is raised from investors in an offering, from about 0 to about $10,000,000 may be used to pay expenses related to the methods of the invention, with from about 0 to about $10,000,000 being used for other purposes.

The phrase “preferred stock” as used herein means capital stock that generally provides a specific dividend that is paid before any dividends are paid to common stock holders, and which takes precedence over common stock in the event of a liquidation. Like common stock, preferred stocks represent partial ownership in a company, although preferred stock shareholders generally do not enjoy any of the voting rights of common stockholders. Also unlike common stock, a preferred stock generally pays a fixed dividend that does not fluctuate.

The term “premium” as is used herein means an amount of money (or other asset) paid or payable, often in monthly or other periodic installments, for an insurance policy, annuity or similar device or instrument.

The phrase “private company” as used herein means a company whose shares are not traded on the open market.

The phrase “private equity” as is used herein means equity capital that generally is made available to business entities in exchange for the entities' securities, through an offering that is exempt from registration with the SEC. The funds that are raised through private equity generally are used to develop new products and technologies, to expand working capital, to make acquisitions, to strengthen a company's balance sheet, and the like.

The phrases “Private Placement Offering Memorandum,” “Confidential Private Placement Offering Memorandum,” “Offering Memorandum” and “PPM” as are used herein mean a document that generally states the objectives, risks and terms of investment involved with a private placement (i.e., securities that are not publicly offered), and that outlines the terms of securities to be offered in the private placement. This generally includes items such as financial statements, risk disclosures, management biographies, detailed description of the business, and the like. It is a legal document through which an issuer of securities offers its securities to prospective investors in a transaction intended to be exempt from registration with the Securities Exchange Commission. An Offering Memorandum generally serves to provide buyers with information on the Offering, and to protect the sellers from the liability associated with selling unregistered securities. The structure of the Offering Memorandum somewhat resembles a business plan in both layout and detail, and permits a company the ability to raise capital through the private sale of equity or debt securities. Under the Securities Act of 1933, any offer to sell securities must either be registered with the SEC or meet an exemption. Regulation D contains three rules providing exemptions from the registration requirements, allowing some smaller companies to offer and sell their securities without having to register the securities with the SEC. While companies using a Regulation D exemption do not have to register their securities, and usually do not have to file reports with the SEC, they must file a “Form D” after they first sell their securities. Form D is a brief notice that includes the names and addresses of the company's executive officers and stock promoters, but contains little other information about the company. For example, the Private Placement Offering Memorandum may set forth the terms and/or conditions of a Unit Offering having two (or more) investment components including:
(1) membership interests in a Limited Liability Company (LLC) (or other Pass Through Business Entity) usually formed by the Issuer (the “LIBAC^{SM} LLC”), that will own the LIBAC^{SM} Assets; and
(2) the Issuer's securities.

The term “pro forma” as is used herein means a method of calculating financial results in order to emphasize either current or projected figures.

The phrase “public company” as used herein means a company that has issued securities which are traded on at least one stock exchange or over-the-counter market.

The phrase “Qualified Institutional Buyer” as used herein is defined in Rule 144A promulgated under the Securities Act of 1933, which is hereby incorporated herein by reference in its entirety, and generally means a purchaser of securities that is deemed financially sophisticated, and is legally recognized by security market regulators to need less protection from Issuers than most public investors. Typically, the qualifications for this designation are based on an Investor's total assets under management, as well as specific legal conditions in the country where the fund is located. This primarily refers to institutions that manage at least $100 million in securities, including banks, savings and loans institutions, insurance companies, investment companies, employee benefit plans, or an entity owned entirely by qualified investors. Also generally included are registered broker-dealers owning and investing, on a discretionary basis, $10 million in securities of non-affiliates.

The phrase “related annuity” as is used herein means a Single Premium Immediate Annuity whose measuring life is the life of the Insured of a life insurance policy and refers to this relational aspect vis-à-vis the related life insurance policy.

The phrases “related policy” and “related life insurance policy” as are used herein mean a life insurance policy whose measuring life is the same life as the measuring life of a Single Premium Immediate Annuity and refers to this relational aspect vis-à-vis the related Single Premium Immediate Annuity.

The phrase “remaining net balance” as used herein means a portion of total invested funds remaining after deducting funds used to acquire any LIBAC^{SM} Assets and/or Offering expenses.

The phrases “return of investment” and “ROI” as used herein mean the amount of profit (return) based on the amount of resources (funds or principal) used to produce it. It is usually expressed as a percentage, for example, 0%, 10%, 20%, 30%, 40%, 50%, 60%, 70%, 80%, 90%, 100%, 200%, 300%, 400%, 500%, 600%, 700%, 800%, 900%, 1000% and so forth, and is a measure of profitability.

The phrase “revocable trust” as used herein means a trust that may be altered or terminated during the grantor's lifetime. Since the trust may be altered at any time until the grantor's death, it is generally considered part of the grantor's estate and is subject to taxation. However, this is not the case where the grantor transfers or assigns all trust powers over the revocable trust through, for instance, a Revocable Trust Powers Assignment. The property is passed on to the beneficiaries only after the grantor's death, and the revocable trust then becomes irrevocable.

The phrases “revocable life insurance trust” and “common law revocable life insurance trust” as used herein mean a revocable trust that is recognized under the common law of the state in which a grantor resides, and whose trust res is a life insurance policy on the life of the grantor, or of the grantor's spouse, and possibly at some future time a Single Premium Immediate Annuity on the same life.

The term “risk” as is used herein means the likelihood of loss of invested capital and/or less-than-expected returns, such as 0% meaning no risk and 100% meaning certainty of loss of invested capital. For example, principal risk is the risk of losing all or part of the amount invested due to default, insolvency, bankruptcy, litigation and/or the like. There is generally usually a possibility that through some set of circumstances, invested capital will decrease or completely disappear. In this case, principal (amount originally invested) is lost, not just profits. The phrases “low risk” and “minimal risk” as are used herein to mean a relatively small chance of losing all, or a part of, invested capital (preferably less than about 25%, more preferably less than about 20%, still more preferably less than about 15%, still more preferably less than about 10%, still more preferably less than about 5%, and most preferably less than 1%). “Minimized risk” refers to taking known risks, as usually disclosed in a “Risk Disclosure” section of a Private Placement Offering Memorandum, of losing all or a part of invested capital, usually related to an Issuer's operations, litigation and/or securities risks (liquidity in the marketplace, failing to timely report to the SEC, losing a listing on a national exchange, and the like) and with the systems and methods of the present invention, reducing as much as possible through LIBAC^{SM} systems and LIBAC^{SM} processes such risks of loss of invested capital by limiting the risks to risks of the LIBAC Assets performing as expected, e.g. that the Insurer will be solvent and will pay death benefits, that the annuity company will remain solvent and pay SPIA payments as, and when scheduled, that trustees won't increase fees beyond the ability of the SPIA payments to pay such fees, and the like.

The phrase “Rule 144” as used herein mean an SEC rule specifying the conditions under which a holder of restricted or controlled securities may publicly sell them. If certain conditions are met, the holder must file a formal registration statement with the SEC, Form 144. This rule allows executives who hold very large blocks of their company's stock to sell a portion of that stock every 12 months.

The phrases “SEC” and “Securities and Exchange Commission” as used herein mean the primary federal regulatory agency for the securities industry, whose responsibility is to promote full disclosure and to protect investors against fraudulent and manipulative practices in the securities markets. It enforces, among other acts, the Securities Act of 1933, the Securities Exchange Act of 1934, the Trust Indenture Act of 1939, the Investment Company Act of 1940 and the Investment Advisors Act, all of which are hereby incorporated herein by reference in their entireties, and can be accessed via the Internet web site sec dot gov.

The term “security,” and in its plural form “securities,” as are used herein means an investment instrument, generally other than an insurance policy or fixed annuity, that is issued by an entity, such as a corporation, which offers evidence of debt or equity, for example, a note, a stock (common, preferred and the like), a treasury stock, a bond, a debenture, a certificate of interest or participation in any profit-sharing agreement or in any oil, gas, or other mineral, a royalty, a lease, any collateral trust certificate, a preorganization certificate or subscription, a transferable share, an investment contract, a voting-trust certificate, a certificate of deposit, any put, call, straddle, option or privilege on any security, certificate of deposit or group or index of securities, or any put, call, straddle, option, or privilege entered into on a national securities exchange relating to foreign currency or, in general, any instrument commonly known as a ‘security’; or any certificate of interest or participation in, temporary or interim certificate for, receipt for, or warrant or right to subscribe to or purchase, any of the foregoing.

The phrase “self-liquidating” as is used herein in connection with a note (or other) structure means the use of one or more financial instruments that provide proceeds from which an obligation may be paid or retired from such proceeds.

The term “share” as used herein means a unit of account (i.e., a standard monetary unit of measurement of the market value/cost of goods, services and/or assets) for various financial instruments including stocks (ordinary or preference), and investments in mutual funds, limited partnerships and Real Estate Investment Trusts (REITs). The common feature of the foregoing is equity participation.

The abbreviation “SPAC” as used herein means Special Purpose Acquisition Company, which typically is a publicly-traded buyout company that raises money in order to pursue the acquisition of an existing company. SPACs typically raise blind pool money (most of which generally goes into a trust) from the public for an unspecified merger, sometimes in a targeted industry. Each SPAC is typically sold at about $6 per unit for one share of common stock (to be publicly-traded in the future) and two warrants that can purchase additional shares. Generally, if an acquisition is not made in two years, the money is returned to the original investors.

The phrase “Special Purpose Life Insurance Policy” as is used herein means a life insurance policy that provides for the payment of the death benefit at the earlier of the insured's death or some specific date, which is usually at age 100, the terms of which may be set forth in a rider to the insurance contract.

The terms “SPIA” and “Single Premium Immediate Annuity” as are used herein mean a type of annuity that permits an individual or entity to immediately convert a lump sum of money, paid all at once to the entity that issues the annuity contract, into a guaranteed payout of money for either as long as the individual lives, or for a specified number of years.

The phrase “sole manager-member” as used herein means an individual or entity that is a member of an entity, such as a Limited Liability Company or other Pass Through Business Entity, and is the sole manager of that entity.

The phrases “stock market” and “equity market” as are used herein mean a private or public market for the trading of company stock and derivatives of company stock at an agreed price; these are securities (notes, stocks, preferred shares, bonds, debentures, options, futures, swaps, rights, warrants and/or virtually any other financial asset.) listed on a stock exchange (generally an association of stockbrokers who meet to buy and sell stocks, bonds and/or other financial assets according to fixed regulations), and/or traded only privately.

The phrase “Subscription Agreement” as used herein means an agreement that an Investor signs and returns to an Issuer with a check, money order, wire transfer or other means of providing the invested funds.

The phrase “substantial return of investment” as is used herein means a return of investment that preferably is at least about 5%, that more preferably is at least about 25%, that still more preferably is at least about 50%, that still more preferably is at least about 75%, that still more preferably is at least about 100%, that still more preferably is at least about 125%, and that still more preferably is at least about 150%, with a range of from about 150% to about 500% being typical.

The term “tranche” as is used herein means one of several related securities, generally offered at the same time. Tranches from the same offering usually have different risk, reward, and/or maturity characteristics, but as used herein, different tranches are meant to provide similar risk, reward and maturity characteristics, and simply refer to the timing of more than one funding under an offering.

The term “trust” as used herein means a legal arrangement and/or agreement in which an individual (the grantor) gives fiduciary control of property (money, invested funds, stocks, bonds, mutual funds, real estate, personal property, intellectual property and/or the like) to a person or entity (the trustee) for the benefit of one or more beneficiaries.

The term “trustee” as used herein means an individual, entity or organization that holds, manages and invests assets for the benefit of another. The trustee is legally obliged to make all trust-related decisions with the beneficiary's interests in mind, and may be liable for damages in the event of not doing so. Trustees may be entitled to a payment for their services, if specified in the trust deed or trust agreement. The trustee usually has broad discretionary powers to select, retain, invest, re-invest, manage, exchange and dispose of trust property.

The phrase “Unit Offering” as is used herein means an offering of securities comprised of: (1) the Issuers securities; and (2) membership interests in the LIBAC^{SM} LLC or other form of Pass Through Business Entity.

The phrase “variable life insurance” as used herein means a type of life insurance policy that may build cash value, in which the cash value may be invested in a variety of separate accounts, similar to mutual funds, and in which the choice of which of the available separate accounts to use is generally entirely up to the life insurance policy owner.

The phrase “venture capital” as is used herein means a type of private equity capital that is typically provided to early-stage, high-potential, growth companies with the expectation of generating a return on investment through an eventual liquidity event such as an IPO or merger or sale of the company. Venture capital investments are generally made as cash in exchange for shares in the invested company. Venture capital typically comes from institutional investors and high net worth individuals, and is generally pooled together by dedicated investment firms.

The phrase “warrant” as is used herein means a certificate, usually issued along with a bond or preferred stock, entitling the holder to buy a specific amount of securities at a specific price, usually above the current market price at the time of issuance, for an extended period, anywhere from a few years to forever. In the case that the price of the security rises to above that of the warrant's exercise price, then the investor can generally buy the security at the warrant's exercise price and resell it for a profit. Otherwise, the warrant will simply expire or remain unused. Warrants are listed on options exchanges and may trade independently of the security with which it was issued.

General Description and Utility

The present invention advantageously provides unique systems and methods for investors to invest in a new start-up, potential high growth (or other) company or business entity, and potentially make a substantial return on their investment while minimizing the risk of a loss of invested capital (i.e., having a maximized risk/investment return ratio), using a unique combination of various investment vehicles and insurance products, including in force life insurance policies held on individuals preferably ranging in age from about 65 to about 85 years (Insureds), Single Premium Immediate Annuities, and LIBAC^{SM} distributions, to provide the assurance of return of invested capital. Very advantageously, the systems and methods of the invention generally guarantee through life insurance policies and related annuities that Investors will receive a return on their invested principal, and potentially a very high return of investment, in what would otherwise be a relatively high risk venture (purchasing of securities in a new start-up or potential high growth company). Additionally, these systems and methods may advantageously generate assets and revenue that may help a new start-up or potential high growth company to “go public” (i.e., have its securities traded in a public market).

Structures using a portfolio of LIBAC^{SM} Assets to protect investment principal are designed to be used in nearly any type of investment transaction. How LIBAC^{SM} Assets are created is similar in most investment transactions, and may readily be determined by those of ordinary skill in the art. While the following percentages may vary widely (from 1% to 100%), and may readily be determined by those of ordinary skill in the art with respect to a particular type of investment transaction:
about 40% of funds raised preferably go to a LIBAC^{SM}, LLC (or other Pass Through Business Entity) to purchase “Fully-Funded” LIBAC^{SM} Assets similar to, equal to, or more than, the total amount of money to be raised; and
about the remaining 60% (less commissions and Offering expenses) is preferably invested in the Issuer's securities, each preferably placed through a Unit Offering.
   How the funds are invested, what securities are sold by the Issuer, and what mechanism is used to measure, or cause, a transfer of the LIBAC^{SM} Assets to the Issuer or Investment sponsor, may each vary widely, and may readily be determined by those of ordinary skill in the art. Examples of four specific investment categories that illustrate LIBAC^{SM} Offerings, and what mechanism is to be used to measure and cause the transfer of the LIBAC^{SM} Assets to the Issuer (“Investment Milestone”), are set forth below, and in Examples 2-5.
   Fund Transactions or Direct Participation Programs (“FUND”) Investments
   Private Investments in Public Equities (“PIPE”) Investments
   Private and Public Company Notes or Debt (“Debt”) Investments
   Hybrid Debt/Equity (“Hybrid”) Investments
      In Examples 2-5, each example profiles a different Offering Amount, including the recommended maximum and minimum amount to be raised for that investment category. To provide a detailed explanation of each LIBAC^{SM} investment structure, a Sample Term Sheet “worksheet” form, detailing each of the Investment categories is used.

Once a Minimum Offering amount is achieved, preferably forty percent (40%) of the invested funds would be released from a securities escrow to a Life Settlement escrow to fund the purchase of LIBAC^{SM} Assets. Through the Life Settlement escrow, with the possible assistance of others, the LIBAC^{SM} LLC, or other type of Pass Through Business Entity, would acquire, through a series of Trusts, which may include a Master Life Insurance Trust that acquires through a series of Revocable Life Insurance Trusts, “fully funded” senior life settlement life insurance policies with combined life insurance policy face values similar to, equal to, or more than, the gross amount of invested funds. Unless otherwise designed, the LIBAC^{SM} Assets will typically carry an average life expectancy of approximately 15 years. However, this number may vary, and may readily be determined by those of ordinary skill in the art. For each Offering tranche, the allocated amount of Offering proceeds are distributed to the Life Settlement escrow, and the balance of funds held in the securities escrow are released to the Issuer, after payment of commissions and Offering expenses, for the Issuer's issuance of equity interests or other type of securities.

Once in place, the LIBAC^{SM} Assets generally provide the Investors with a bankrupt proof collateral back-stop pool of “fully funded” senior life settlement insurance policies with combined face-values equal to, or more than, the total amount invested, assuring a return of the Investors' original invested principal if the Issuer's business plans fail to produce the required or stated returns and/or results. If a life insurance policy matures before the Issuer has met its pre-determined Investment Milestone(s), the Investors would generally be entitled to all LIBAC^{SM} LLC distributions for that policy's death benefit; however the LIBAC^{SM} LLC may accumulate some portion of such proceeds for distributions to include the Issuer if, and when, the Issuer reaches the Investment Milestone(s) within a specified period of time. Once the Issuer has met its Investment Milestone(s), some or all of the LIBAC^{SM} LLC membership interests, depending upon the terms usually set forth in the Operating Agreement(s) and disclosed in the Confidential Private Placement Offering Memorandum, will typically automatically revert to the Issuer. At that point, the Issuer may possibly use this collateral asset in one of three (or other) ways:
(1) sell the LIBAC^{SM} Assets;
(2) re-deploy the LIBAC^{SM} Assets in a second planned Offering; or
(3) the LIBAC^{SM} Assets would become subject to the terms and conditions of a Repurchase Agreement between a Patent Holder and the Issuer pursuant to the terms of a patent licensing agreement (in connection with the present invention).
Example: An Investor invests $1,000,000 in the Unit Offering, which is deposited into a securities escrow account. $400,000 (40% of total invested assets) is transferred to the Life Settlement escrow account and used to acquire “fully funded” LIBAC^{SM} Assets with combined life insurance policy face values equal to, or more than, $1,000,000, assuring that the Investor will receive a return of his/her principal investment, regardless of the outcome of the Issuer's success. The Issuer receives the balance of invested funds, $600,000 (less offering costs and broker-dealer commission) for the Issuer's securities. Once the Issuer has attained its one or more pre-determined Investment Milestone(s), the LIBAC^{SM} Assets, usually through an automatic transfer provided for in the Operating Agreement of membership interests in the LIBAC^{SM} LLC, or other Pass Through Business Entity, are transferred to the Issuer, and usually become subject to a patent holder's Repurchase Agreement.

A general description of preferred embodiments of the methods of the present invention is set forth below. One preferred embodiment of the present invention is as described below.

### Creation of Revocable Life Insurance Trusts

An individual ranging in age from about 65 to about 85 years, and more preferably from about 70 to about 80 years, who is preferably a resident of a state of the United States (the “Insured”), as grantor, creates a common law Revocable Life Insurance Trust under the laws of his or her state of residence (Insured's Residence State), which is preferably a “grantor trust” within the meaning of United States Code Section 676 and the Internal Revenue Code, both of which are incorporated herein in their entireties by reference. The Insured contributes as the initial corpus to the Revocable Life Insurance Trust an in force non-variable life insurance policy, for example, having a $1,000,000.00 death benefit, which insures his or her life, or the life of his or her spouse, and has been in force for more than two (2) years and, thus, is beyond its contestability period (“Life Insurance Policy”). Upon the contribution of the Life Insurance Policy to the Revocable Life Insurance Trust, the Revocable Life Insurance Trust becomes the sole owner and sole beneficiary of the Life Insurance Policy. The beneficiary or beneficiaries of the Revocable Life Insurance Trust are preferably individuals who, on the date of the issuance of the policy and, preferably also on the date of the Insured's contribution of the Life Insurance Policy to the Revocable Life Insurance Trust, have or had an insurable interest in the life of the Insured under the laws of the Insured's Residence State, which may or may not be a state that regulates the sale of an in force life insurance policy as a viatical or life settlement transaction. The trustee of the Revocable Life Insurance Trust (the “Trustee”) will preferably: (a) be a resident of the Insured's Residence State; (b) be qualified under the trust law of the Insured's Residence State to serve as trustee of the Revocable Life Insurance Trust; (c) be unaffiliated with the Investors and Issuer described hereinbelow, and/or their directors, officers, managers and/or employees; and (d) administer the Revocable Life Insurance Trust in, and from, the Insured's Residence State. In most situations, the Insured will serve as the initial Trustee of the Revocable Life Insurance Trust.

The face value and death benefit of each in force non-variable life insurance policy may vary widely, but preferably ranges from about $100,000 to about $5,000,000, and more preferably ranges from about $250,000 to about $2,000,000, and most preferably ranges from about $500,000 to about $1,000,000, for example, $1,000,000.00. Such death benefits generally provide an assurance of the return of each Investor's total principal investment, including the investment in the new start-up or other type of Issuer's securities.

### Investment of Funds by Investors

An issuer (“Issuer”), which is preferably an entity, preferably forms, and preferably designates a subsidiary of the patent holder to be the sole manager, preferably a non-equity manager, of a new Limited Liability Company (“LLC”), or other type of Pass Through Business Entity, under the laws of a state of the United States. Preferably, a Limited Liability Company Operating Agreement (or other business governing agreement) is drafted and governs the operation of the Limited Liability Company. The Limited Liability Company (or other Pass Through Business Entity) offers for sale new-issue “membership interests” in the Limited Liability Company (or other Pass Through Business Entity) to one or more Investors in exchange for a portion of investment funds invested by the Investors (preferably a minority of the total amount of investment funds invested by the Investors). Preferably, by way of a Confidential Private Placement Offering Memorandum as a part of this same Offering, the Issuer then offers for sale one or more classes of “equity interests” and/or “debt securities” of the Issuer to one or more Investors in exchange for the remaining portion (preferably a majority, and after Offering expenses) of the total amount of investment funds paid by the Investors for this investment. The Investor(s) then become the non-manager member(s) of the Limited Liability Company (or other Pass Through Business Entity). The Limited Liability Company as a grantor forms a Master Life Insurance Trust, and uses its portion of the investment proceeds to fund this trust, which is preferably formed under the laws of a state or jurisdiction of the United States, of which the Limited Liability Company is preferably the sole beneficiary.

Following its funding, the Master Life Insurance Trust acquires from one or more Revocable Life Insurance Trusts the right to receive LIBAC^{SM} distributions comprising:
(1) the death benefits under the one or more in force, non-variable (or other) life insurance policies having a total face value that is similar to, equal to, or in excess of, the total amount of funds raised (funds invested by the Investors) in the Offering; and
(2) the portion of annuity payments made under one or more Single Premium Immediate Annuities (each a SPIA) that is in excess of the amounts of money that are required to pay:
   (i) the premiums due for such non-variable (or other) life insurance policies;
   (ii) trust administrative expenses;
   (iii) taxes related to SPIA income; and/or
   (iv) other expenses;
wherein the Single Premium Immediate Annuities are preferably measured by the lives of the Insureds under the non-variable (or other) life insurance policies.

The Limited Liability Company's beneficial interest in the Master Life Insurance Trust and, therefore, the beneficial interest in Single Premium Immediate Annuity payments, serve to provide the Limited Liability Company with a source of-funds for payment of taxes by its members on the taxable portion of the Single Premium Immediate Annuities. The Limited Liability Company's beneficial interest in the Master Life Insurance Trust and, therefore, the beneficial interest in the LIBAC^{SM} distributions, serve to provide the Limited Liability Company with a source of funds for
(i) repayment to each Investor of the principal amount of his or her investment made pursuant to the Offering; and
(ii) optionally, a return on investment.

The Issuer utilizes the balance, after Offering expenses, of invested funds paid for its securities for its business purposes to preferably enhance the value of the securities issued to the Investor(s). Under one embodiment of the invention, the Issuer may or may not be entitled to participate in the Limited Liability Company's distributions of LIBAC^{SM} distributions to its non-managing members (the Investor(s)), depending upon an achievement by the Issuer of one or more Investment Milestones regarding the Investors' investment in the Issuer's “equity” and/or “debt securities,” which milestones preferably are set forth in a Limited Liability Company Operating Agreement, and disclosed in a Confidential Private Placement Offering Memorandum or prospectus. In the event the Issuer fails to achieve such Investment Milestones, which preferably provide for a liquidity event for the Investor(s) to receive a return of at least the principal amount of their investment in the Offering, the Investor(s) are repaid the principal amount of their investments made pursuant to the Offering via the Limited Liability Company's beneficial interest in the Master Life Insurance Trust and, therefore, the beneficial interest in LIBAC^{SM} distributions as life insurance policies mature.

The lump sum payment for each Single Premium Immediate Annuity may vary widely, but preferably ranges from about $22,000 to about $1,100,000, and more preferably ranges from about $55,000 to about $440,000, and most preferably ranges from about $110,000 to about $220,000.

The periodic annuity payments that are made under each Single Premium Immediate Annuity may vary over a wide variety of periods of time. They may be made periodically over any period of time, for example, weekly, bimonthly, monthly, quarterly, biannually, annually and so forth. Preferably, the annuity payments are made periodically, and each period of time ranges from about monthly to about annually, and most preferably ranges from about quarterly to about annually. The cash flow provided by each Single Premium Immediate Annuity preferably continues until the death of the corresponding Insured because the life of the Insured is preferably also used to measure both the non-variable life insurance policy and the related annuity. However, it is also possible to use some other fixed period of time, e.g., until the Insured reaches the age of 100 where the policy related to the Single Premium Immediate Annuity is a Special Purpose Life Insurance Policy maturing when the insured obtains the age of 100. Upon the death of the Insured, generally:
(i) the annuity terminates; and
(ii) death benefits of the non-variable life insurance policy are paid out to the Investor(s) through the Limited Liability Company (of other Pass Through Business Entity) and, possibly, also to the Issuer.

### Revocable Trust Powers Assignment

The Limited Liability Company (or other Pass Through Business Entity), as grantor, forms the Master Life Insurance Trust and, as noted above, is the sole beneficiary of this trust. The Limited Liability Company funds the Master Life Insurance Trust from the portion of the investment proceeds from the Offering that was contributed to the Limited Liability Company. The Master Life Insurance Trust uses these funds to purchase from each Insured an assignment by the Insured of all of his or her rights and powers to amend, change, revoke and/or supplement the trust agreement that governs the Revocable Life Insurance Trust (the “Revocable Trust Powers Assignment”), and will thereby amend the Revocable Life Insurance Trust to name the Master Life Insurance Trust as the beneficiary, and preferably the sole beneficiary, of the Revocable Life Insurance Trust, and to name a new trustee of the Revocable Life Insurance Trust, which is designated by the Master Life Insurance Trust or the Limited Liability Company. From part of the purchase price paid by the Master Life Insurance Trust to the Insured for the Revocable Trust Powers Assignment, which part is advanced to the Insured after a Revocable Trust Powers Assignment contract is executed, the Insured causes the Revocable Life Insurance Trust to purchase a Single Premium Immediate Annuity (“SPIA”), where the measuring life for the annuity will be the Insured and the sole beneficiary of which will be the Revocable Life Insurance Trust. The purpose for the purchase by the Revocable Life Insurance Trust of the Single Premium Immediate Annuity is to generate annuity payments in amounts that are sufficient to pay:
premiums that become due for the in force, non-variable life insurance policies;
the Trustee's annual fee (both for the Mater Life Insurance Trust and the Revocable Life Insurance Trust);
Limited Liability Company (or other Pass Through Business Entity) administrative expenses; and/or
the income tax due on that portion of Single Premium Immediate Annuity proceeds that are taxable, based upon the highest personal income tax bracket.

### LIBAC^{SM} Agreement

The Master Life Insurance Trust and the Insured will preferably enter into a written agreement for the Revocable Trust Powers Assignment and the Single Premium Immediate Annuity Purchase (collectively called the “LIBAC^{SM} Agreement”). Under the LIBAC^{SM} Agreement, the Insured will preferably agree to cause the Revocable Life Insurance Trust to purchase the Single Premium Immediate Annuity, and the Master Life Insurance Trust will advance funds to the Insured, which funds the Insured will be required to use to pay for the purchase of the Single Premium Immediate Annuity by the Revocable Life Insurance Trust. The LIBAC^{SM} Agreement will also preferably provide that, promptly following the Revocable Life Insurance Trust's purchase of the Single Premium Immediate Annuity: (1) the Insured will effect the Revocable Trust Powers Assignment to the Master Life Insurance Trust; and (2) the Master Life Insurance Trust will pay to the Insured the balance of the purchase price of the Revocable Trust Powers Assignment (together with the funds used to acquire the Single Premium Immediate Annuity, the “Revocable Trust Powers Assignment Payment”). As soon as the LIBAC^{SM} Agreement is executed by the parties, the first portion of this fee is paid to the Insured. Preferably, neither the Trustee, nor any beneficiary, of the Revocable Life Insurance Trust will receive any compensation from the Master Life Insurance Trust, or from any person in connection with the LIBAC^{SM} Agreement. Preferably, the transaction will be processed by an escrow company familiar with life settlement transactions.

### Parties to Methods

The parties that are preferably involved in this preferred embodiment of the present invention are described below.
Issuer: The Issuer preferably:
   forms, and designates a subsidiary of the Patent Holder as the sole manager of, a new Limited Liability Company (LLC) (or other Pass Through Business Entity);
   offers for sale (via an “Offering”), as part of the Units being offered to the Investors its “equity interests” and/or “debt securities” in exchange for the balance of investment proceeds not used to purchase LLC “membership interests” (or other Pass Through Business Entity) (preferably a majority amount thereof); and
   optionally shares in the LIBAC^{SM} distributions, depending upon achieving certain pre-specified Investment Milestones (preferably as set forth in an LLC Operating Agreement and Offering document).
Investors: One or more Investors preferably:
   purchase from the LLC (or other Pass Through Business Entity) new-issue “membership interests” of the LLC in exchange for a portion of the investment proceeds (preferably a minority amount thereof), and become non-manager members; and
   purchase from the Issuer its “equity interests” and/or “debt securities” in exchange for the remaining portion, after Offering expenses, of the investment proceeds (preferably a majority amount thereof); and
   eventually receive all or a portion of the LIBAC^{SM} distributions and, hopefully receive a return of the securities issued by the Issuer such that, collectively with the LIBAC^{SM} distributions, the investor(s) receive a high return of investment, but minimally a return of the investor(s)' investment.
Limited Liability Company (LLC): The Limited Liability Company (or other type of Pass Through Business Entity) preferably:
   forms a Master Life Insurance Trust;
   offers for sale (via an “Offering”), as part of the Units being offered to the Investors new-issue “membership interests” in the Limited Liability Company (or other Pass Through Business Entity) in exchange for a portion of the investment proceeds (preferably a minority amount thereof) and issues its “membership interests” to Investors;
   uses the investment proceeds that it receives from Investors (those generated by the new-issue “membership interests” in the LLC (or other Pass Through Business Entity) to fund the Master Life Insurance Trust, whose sole purpose is to acquire the trust powers of the Revocable Life Insurance Trusts, and thereby all beneficial interests in the LIBAC^{SM} Assets; and
   is the sole beneficiary of the Master Life Insurance Trust.
Master Life Insurance Trust: This trust preferably:
   acquires, through a Revocable Trust Powers Assignment from one or multiple Insureds the beneficiary right to receive payment of:
      the death benefits once the Insureds die, or the life insurance policies otherwise mature, under the non-variable life insurance policies (having a total face value equal to, or in excess of, the total amount of the funds that are raised from the Investors in the Offering); and
      the annuity payments made under Single Premium Immediate Annuities (SPIAs) (measured by the lives of the Insureds under the non-variable life insurance policies), which proceeds are used to pay the premiums due for such life insurance policies, the Revocable Life Insurance Trust's and the Master Life Insurance Trust's trustee fees, Limited Liability Corporation (or other Pass Through Business Entity) administrative fees, and/or taxes on the taxable portion of the annuity payments;
   advances funds to the Insured, which the Insured is required to use to pay for the purchase of the Single Premium Immediate Annuity(ies), using the Insured's life as the measuring life, by the Revocable Life Insurance Trusts (under the LIBAC^{SM} Agreement); and
   then:
      simultaneously with the assignment of trust powers, amends the Revocable Life Insurance Trust to name the Master Life Insurance Trust as the sole beneficiary of the Revocable Life Insurance Trust and to designate itself, as the beneficiary, as having the power to modify, amend, or revoke the trust and as having the power and right to sell its trust powers; and
      names a new Trustee of the Revocable Life Insurance Trust;
   by way of an agreement with each Insured, uses the funds provided to it by the Limited Liability Company (or other Pass Through Business Entity) to purchase from each Insured an assignment by the Insured to the Master Life Insurance Trust of all of his or her rights and powers to amend, change, revoke and/or supplement the trust agreement and the power and right to sell its trust powers over the Revocable Life Insurance Trust (collectively known as a “Revocable Trust Powers Assignment”), and has each Insured agree to cause the Revocable Life Insurance Trust to purchase the Single Premium Immediate Annuity(ies) (collectively known as “the LIBAC^{SM} Agreement”); and
   additionally pays to the Insured the balance of the purchase price for the Revocable Trust Powers Assignment.
Beneficiary (Sole) of the Master Life Insurance Trust:
   The Limited Liability Company (or other Pass Through Business Entity) is a beneficiary of, and preferably the sole beneficiary of, the Master Life Insurance Trust.
Trustee of the Master Life Insurance Trust:
   Preferably, the Limited Liability Company (or other Pass Through Business Entity), as grantor and through its manager, selects the trustee of the Master Life Insurance Trust. The trustee of this trust preferably is also the trustee of every Revocable Life Insurance Trust upon completion of the assignment under the Revocable Trust Power Assignment.
Insureds: Each of the one or more Insureds preferably:
   is an older person (from about 65 to about 85 years of age, and preferably from about 70 to about 80 years of age), whose life is insured under an in force non-variable (or other) life insurance policy that has been in force for more than 2 years and has a death benefit, and whose life expectancy is preferably about 12 years or more, and more preferably is from about 14 to about 16 years;
   as a grantor, creates a common law Revocable Life Insurance Trust;
   then, contributes as the initial corpus to the Revocable Life Insurance Trust the in force non-variable life insurance policy (with the corresponding death benefit);
   by way of an agreement with the Master Life Insurance Trust, assigns to such trust all of his or her rights and powers to amend, change, revoke and/or supplement the trust agreement for the Revocable Life Insurance Trust (preferably under a “Revocable Trust Powers Assignment”), and agrees to cause the Revocable Life Insurance Trust to purchase the Single Premium Immediate Annuity(ies) using the Insured's life as the measuring life for the annuity (preferably under a “LIBAC^{SM} Agreement”);
   receives advance funds from the Master Life Insurance Trust, which the Insured is required to use to pay for the purchase of the Single Premium Immediate Annuity by the Revocable Life Insurance Trust (preferably under the LIBAC^{SM} Agreement);
   causes the Revocable Life Insurance Trust to purchase a Single Premium Immediate Annuity (using part of the purchase price advanced by the Master Life Insurance Trust to the Insured, preferably under the LIBAC^{SM} Agreement, for the “Revocable Trust Powers Assignment”);
   additionally receives from the Master Life Insurance Trust the balance of the purchase price for the Revocable Trust Powers Assignment; and
   is eventually taken out of this process, except for periodic contact as set forth in the Revocable Trust Powers Assignment, and then is only used as a measuring life for a corresponding in force non-variable life insurance policy and annuity.
Single Premium Immediate Annuities (SPIAs): The SPIAs preferably:
   earn income (taxable) and return of principal (non-taxable) that is used to pay the premiums for the in force non-variable life insurance policies, annual trustee fees, LLC administrative expenses, and/or taxes on that portion of the Single Premium Immediate Annuity proceeds that are taxable; and
   terminate upon the death of the Insured or upon the earlier of age 100 or the death of the insured.
Beneficiary (Sole) of the Single Premium Immediate Annuity:
   The sole beneficiary of the Single Premium Immediate Annuity is preferably the Revocable Life Insurance Trust.
Revocable Life Insurance Trust: The Revocable Life Insurance Trust preferably:
   is the sole owner and the sole beneficiary of the Insured's in force non-variable (or other) life insurance policy;
   purchases a Single Premium Immediate Annuity(ies) (using part of the purchase price advanced by the Master Life Insurance Trust to the Insured for the Revocable Trust Powers Assignment), whose measuring life is the Insured, for the purpose of generating annuity payments in amounts that are sufficient to pay:
      the premiums due for the in force non-variable life insurance policy;
      the trustee fees;
      Limited Liability Company (or other Pass Through Business Entity) administrative expenses; and/or
      income tax that is due on that portion of the Single Premium Immediate Annuity proceeds that are taxable (income only), which Single Premium Immediate Annuity terminates when an Insured dies, or possibly reaches age 100 or some other predetermined age; and
   has one or more beneficiaries (of the Revocable Life Insurance Trust) who, on the date of the policy issuance, and preferably also on the date of the Insured's contributions of the in force non-variable life insurance policy to the Revocable Life Insurance Trust, are preferably individuals that have or had an insurable interest in the life of the Insured.
Beneficiaries of Revocable Life Insurance Trust: The beneficiaries of the Revocable Life Insurance Trust preferably:
   initially (before the Master Life Insurance Trust amends the Revocable Life Insurance Trust), are individuals who, on the date of the life insurance policy is issued, and preferably also on the date of the Insured's contributions of the in force non-variable life insurance policy to the Master Life Insurance Trust, have or had an insurable interest in the life of the Insured;
   subsequently (after the Master Life Insurance Trust amends the Revocable Life Insurance Trust), is the Master Life Insurance Trust; and
   has initial beneficiary(ies) that will not receive any compensation from the Master Life Insurance Trust, or from any other person in connection with the LIBAC^{SM} Agreement.
Trustee of the Revocable Life Insurance Trust: The trustee of the Revocable Life Insurance Trust preferably:
   initially (before the Master Life Insurance Trust receives an assignment of Revocable Life Insurance Trust powers and simultaneously amends the Revocable Life Insurance Trust), is an individual that is unaffiliated with the Investors, the Issuer and/or its directors, officers, managers and/or employees (and preferably is the Insured);
   subsequently (after the Master Life Insurance Trust receives an assignment of Revocable Life Insurance Trust powers and simultaneously amends the Revocable Life Insurance Trust), is a new Trustee that is designated by the Master Life Insurance Trust or the Limited Liability Company as the sole beneficiary of the Master Life Insurance Trust; and
   will not receive any compensation from the Master Life Insurance Trust, or from any other person in connection with the LIBAC^{SM} Agreement, but the successor trustee named by the Master Life Insurance Trust will be paid trustee fees on preferably a quarterly or annual basis.

### Agreements

As is known by those of skill in the art, the methods of investing that are described herein may use one or more of a variety of different legally binding and enforceable agreements or contracts between different parties to govern the various terms and conditions of the different aspects and/or steps of the systems and methods that are described herein (parties, effective date, termination date, location, fees, limitations and the like), for example, life insurance trust agreements, other trust agreements, life insurance agreements, annuity agreements, Offering documents, Subscription Agreements, Revocable Trust Powers Assignment, the Single Premium Immediate Annuity purchase, life settlement agreements, of which the LIBAC^{SM} agreement is a hybrid, business governing agreements, Operating Agreements and the like. The terms and conditions of each of these agreements may vary widely, as is known by those of ordinary skill in the art.

### Rate and Time of Return

In accordance with the systems and methods of the present invention, each Investor is typically assured a return of his total principal investment. Additionally, and very advantageously, each Investor generally receives a return on his principal investment that ranges from about 5% to about 1,000%, or even higher, which is much better than the returns on investments with a similar low risk of return of investment. The investors may receive payments at any time after they make their initial investment. However, they will usually receive payments representing a return of and/or on investment at such time as the issuer is able to successfully implement its business plan, or a significant portion thereof, or as members of the Limited Liability Company, or other Pass Through Business Entity, at a time just after one or more (or all) of the Insureds die, which typically occurs from about two years to about five years after an Investor makes his initial investment (depending upon whether or not one or more of the Insureds has a premature death relative to mortality tables and/or rates and depending upon whether the Issuer is optionally entitled to share in LIBAC^{SM} distributions and the timeframe used to determine milestones). Because the Insureds are each preferably from about 70 to about 80 years of age when the methods of the invention are carried out, all of their deaths will likely occur at some time within the subsequent 25 years or so. The return of investment that an Investor receives can be enhanced if life insurance policies and annuities are selected which, over the entire portfolio of both products, maximize annuity rates and death benefits and minimize the expected cost of the life insurance policies, trust administration fees, Limited Liability Company administrative fees, and taxes. It may be even further enhanced if the issuer successfully implements its business plan or significant portion thereof and creates a liquidity event for the funds invested for the Issuer's securities. By minimizing the costs for purchasing various annuities and life insurance policies, returns for all of the parties involved in the LIBAC^{SM} system or LIBAC^{SM} process, except for Insureds, may be enhanced.

### Number of Investors, Life Insurance Policies, Annuities, Trusts and the Like

The number of investors, life insurance policies, annuities, trusts and the like that may be employed in accordance with the systems and methods of the present invention may vary widely. For example, in one embodiment of the invention, more than 100 accredited Investors may make smaller investments in the LIBAC^{SM} units. Those of ordinary skill in the art may readily determine how many Investors, life insurance policies, annuities, trusts and the like that may be employed in accordance with various different embodiments of the methods of the present invention (i.e., to achieve the investment goals that are described herein).

### Computer Systems

A computer or computer system may, optionally, be employed to practice the systems and methods of the present invention in whole or in part.

As is known by those of ordinary skill in the art, a computer network can be a public network, and typically includes a central processing unit (CPU) that is connected to a system memory, which typically contains an operating system, a driver, one or more application programs, one or more input devices, such as a mouse or a keyboard, one or more output devices, such as a printer, a display monitor, and a communications interface, such as an ethernet card, to communicate to an electronic network, for example, via a Wide Area Network (WAN) or as an inter-network, such as the Internet. Many other similar configurations are known by those of ordinary skill in the art, and it is contemplated that all of these configurations could be used with the present invention. Furthermore, it is within the abilities of one of ordinary skill in the art to program and configure a computer system to implement one or more of the steps of the present invention, as are discussed herein. Moreover, the present invention contemplates providing computer readable data storage means with program code recorded thereon for implementing the method steps that are described herein.

A computer system can, optionally, be employed in connection with the present invention in a manner known by those of ordinary skill in the art to perform, or facilitate, any one or more of the following tasks:
determination of the amount of money to be paid to the owner of a life insurance policy;
determination of the amount of annuity payments that should be received for the life of an Insured;
determination of the return of investment for the Investor(s) if the Issuer is issuing debt securities, and the timing thereof;
determining the amount of risk that may be involved in a particular situation;
managing the costs and/or benefits of practicing the invention in a data base, including cost savings from populating various forms commonly used in Life Settlement transactions with data from a data base;
varying the amounts of some payments based upon variables associated with payments, especially premium payments, for example, the life expectancy of the Insured, interest rates, premium crediting rates and the like, to estimate how one or more other variables could be manipulated or adjusted to return a profit or increase profit;
tracking some or all of the payments, transfers, expirations of Insured(s), and/or other actions associated with the present invention, which may be governed by one or more agreements;
tracking whether one or more of the terms and/or conditions of one or more of the agreements that are associated with the present invention are being fulfilled; and
managing one or more or all of the various embodiments of the present invention.

Such a computer system could be configured to receive inputs from a user, such as a query as to whether an action has been performed, and output the status or lack of status of the action. Still other embodiments could be configured to output reminders, form schedules based on actions associated with the agreements associated with the present invention, and the like, to assist in the practice of the invention and/or to manage the practice of the invention.

Still further, the computer system could be used to estimate the appropriate amount of the various payments that will provide for a given return on investment when used in conjunction with the Issuer's issuance of debt securities and with the assumption that the Insured will live a certain number of years and/or for a fixed period of time or with certain assumptions as to interests rates or premium crediting rates. The logic used to determine the general amount of the payments can be based on the life expectancy of the Insured and or crediting rates. That is, logic can be used to estimate how much money should be paid out in order to obtain an acceptable return on or of investment, assuming that the Insured will only live to his or her expected life expectancy.

In other embodiments of the present invention, logic may include an algorithm to estimate decreases in return on or of investment in the event that the insured lives beyond his or her life expectancy. This life expectancy could be based on a rated age of the Insured. Thus, this would permit the computer system to estimate the periodic payments to be made by simply inputting the rated age of an Insured and comparing the difference to that rated age and a generic number based on the sex of the insured, or alternatively not based on anything (for example, in the event that the rated age takes into account the sex of the insured), so that, for example, the computer system can estimate the payments without requiring a computer system that must rely on and/or be compatible with life actuarial sciences.

Other embodiments of the present invention can be practiced by inputting at least some pertinent information relating to the agreements that are discussed herein (whether consummated, planned to be consummated, or considered as an option) into a computer terminal. For example, a computer terminal could include, or be limited to, a “dumb” monitor linked to a mainframe that could be located in the same building, or same region, with the computer terminal, and could also include a personal computer. This information could then be transferred to a computer that could be a mainframe computer located in the same building, or in another building, or in another region. The computer terminal could be located in one region separate from the region in which the computer to which the information is transferred is located. For example, the computer terminal could be located in one city, state and/or country, and the computer to which the information is transferred could be located in another city, state and/or country.

Embodiments within the scope of the present invention include program products on computer-readable media, and carriers for carrying or having computer-executable instructions or data structures stored thereon. Such computer-readable media can be any available media which can be accessed by a general purpose or special purpose computer, for example, RAM, ROM, EPROM, EEPROM, CD-ROM or other optical disk storage, magnetic disk storage or other magnetic storage devices, or any other medium which can be used to carry or store desired program code in the form of computer-executable instructions or data structures, and which can be accessed by a general purpose or special purpose computer. When information is transferred or provided over a network or another communications connection (generally hardwired, wireless, or a combination of hardwired or wireless) to a computer, the computer properly views the connection as a computer-readable medium. Thus, any such connection is properly termed a computer-readable medium. Computer-executable instructions comprise, for example, instructions and data which cause a general purpose computer, special purpose computer, or special purpose processing device to perform a certain function or group of functions.

The invention is described in the general context of method steps which may be implemented in one embodiment by a program product including computer-executable instructions, such as program modules, executed by computers in networked environments. Generally, program modules include routines, programs, objects, components, data structures, and the like, that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention is suitable for being operated in a networked environment using logical connections to one or more remote computers having processors. Logical connections may include a local area network (LAN) and a wide area network (WAN). Such networking environments are commonplace in office-wide or enterprise-wide computer networks, intranets and the Internet. Such network computing environments typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (by hardwired links, wireless links, or by a combination of hardwired or wireless links) through a communications network. In a distributed computing environment, program modules may be located in both local and remote memory storage devices.

The order of the steps that are described herein may generally be varied, and two or more steps may generally be performed separately, concurrently and/or with partial concurrence. Such variation will depend on the software and hardware systems chosen and on designer choice. All such variations are within the scope of the present invention. Also, software and web implementations of the present invention could be accomplished with standard programming techniques with rule based logic and other logic to accomplish the various database searching steps, correlation steps, comparison steps, decision steps and other steps.

Additional information regarding computers and computing is present in the following books, each of which is hereby incorporated herein in its entirety by reference: (i) Douglas E. Corner, “Computer Networks and Internets with Internet Applications” (5th Edition, Prentice Hall, 2008); (ii) M. Morris Mano and Charles Kime, “Logic and Design Computer Fundamentals” (4th Edition, Prentice Hall, 2003), (iii) Randal E. Bryant and David R. O'Hallaron, “Computer Systems: A Programmer's Perspective” (Prentice Hall, 2002); (iv) William Stallings, “Data and Computer Communications” (8th Edition, Prentice Hall, 2008); (v) Harold Abelson, Gerald Jay Sussman and Julie Sussman, “Structure and Interpretation of Computer Programs,” (2nd Edition, McGraw-Hill, 1996); and (vi) J. Stanley Warford, “Computer Systems” (4th Edition, Jones & Bartlett Pub, 2009).

### Other Embodiments of Invention

The methods of the present invention include many different embodiments and variations.

Another embodiment of the present invention includes the use of term life insurance policies that may at any point during the method be converted to whole life or universal life insurance policies.

A further embodiment of the present invention includes the use of variable life insurance policies.

Yet, another embodiment of the invention includes a structure that does not include Revocable Life Insurance Trusts, and in which an Insured acquires a Single Premium Immediate Annuity, and the Insured's life insurance policy and Single Premium Immediate Annuity are purchased by the Master Life Insurance Trust directly.

A further embodiment of the invention is the same as the embodiment directly above, except that the Limited Liability Company acquires the life insurance policy and Single Premium Immediate Annuity directly, or through a Revocable Life Insurance Trust without the intervening step of the Master Life Insurance Trust acquiring the life insurance policy and Single Premium Annuity directly or through a Revocable Life Insurance Trust.

Yet another embodiment of the invention includes a structure in which a limited partnership entity is used in the place of the Limited Liability Company, where preferably a subsidiary of the Patent Holder is the general partner of the limited partnership, or some other type of Pass Through Business Entity is used, like an S corporation or Delaware Statutory Trust, or a non-profit corporation is used in the place of the Limited Liability Company.

In still another embodiment of the invention, the balance of invested funds do not go to an Issuer who is an operating company, but, rather, to purchase a Single Premium Immediate Annuity with more cash flow. This structure (called a “Life Settlement Backed Bond” or “LSBB”) is almost identical to the LIBAC^{SM} structure, except that the Limited Liability Company is the only Issuer and the balance of funds after the purchase of the life insurance policy are used to purchase as much Single Premium Immediate Annuity cash flow as possible. According to pricing estimates that have been reviewed by the Inventors, Investors can likely achieve, after expenses (life insurance premiums, annuity fees, trust administration fees, taxes and the like), a yield of from about 7% to about 9%, which, when considering the favorable tax treatment of Single Premium Immediate Annuity cash flow, is equivalent to a pre-tax yield of from about 9% to about 11%. These types of returns are highly attractive to institutional investors, especially as a safe alternative to subprime mortgage loans that are no longer being funded.

In yet another embodiment, no trusts are employed, only one type of trust (Revocable Life Insurance Trust or Master Life Insurance Trust) is employed, or a different type of trust is employed.

Sources of Materials

All of the materials and equipment that are employed in the systems and methods of the present invention are commercially available from sources that are known by those of ordinary skill in the art.

The following example describes and illustrates the methods of the present invention. This example is intended to be merely illustrative of the present invention, and not limiting thereof in either scope or spirit. Those of skill in the art will readily understand that variations of certain of the conditions and/or steps employed in the procedures described in the example may be employed.

### EXAMPLE 1

### Sample LIBAC^{SM} Term Sheet

The following is an example of a sample LIBAC^{SM} term sheet that may be employed in the systems and methods of the present invention.
Offering Amount: $10,000,000
Units Offered: 1,000 shares of Pub Co Stock and 1 membership Unit in the LIBAC^{SM} LLC
Unit Price: $10,000
Unit Price Allocation: $6,000 for Pub Co shares ($6 per share) & $4,000 for the LIBAC^{SM} LLC membership Unit
Offering Expenses (10%): $1,000,000
Total LIBAC^{SM} LLC Funding: $4,000,000
Total Pub Co Funding (Net 10% Offering Expenses): $5,000,000 ($6,000,000-$1,000,000 Offering Expenses)
LLC Funding of Revocable Trust Acquisitions: $500,000 for estimated $10,000,000 of face value (Life Insurance Policies)
LLC Funding of Revocable Trust Acquisitions (SPIA): $3,500,000
LLC Distributions Based on Milestones: First two years, all death Benefit proceeds, if any, distributed to Investors. If between two and three years market value of stock increases to min. bid of $12.50 per share for ten or more trading days (providing a potential return of principal and 25% gain), 75% of death benefit distributions to investors and 25% to Pub Co. If between two and three years market value of stock increases to min. bid of $15.00 per share for ten or more trading days (providing a potential return of principal and 50% gain), 50% of death benefit distributions to investors and 50% to Pub Co. If between two and five years market value of stock increases to min. bid of $20.00 per share for ten or more trading days (providing a potential return of principal and 100% gain), 25% of death benefit distributions to investors and 75% to Pub Co.

There are multiple ways to determine Unit price allocation, as would be readily apparent to those of ordinary skill in the art, such as, in the above example with firm percentages to Issuer and Limited Liability Company, with the Limited Liability Company acquiring as much LIBAC^{SM} Assets as possible with or without a stated minimum face value (as a percentage of the Offering such that with a stated minimum face value, if the stated amount could not be purchased at the set allocation amount, the Offering proceeds would be returned to Investors, which would be very unlikely), or a fluctuating percentage of the Offering proceeds, with a set minimum percentage, being used to acquire a set amount of face value, with the balance of the proceeds being used to acquire the security being Offered. In such a scenario, either the price per share would be fixed and the number of shares purchased would vary, or the number of shares purchased would vary and the price per share would be fixed, depending upon the actual LIBAC^{SM} Asset acquisition costs.

There is an estimated Life Insurance policies acquisition cost of about 5% face value in this example. It is expected that it would be possible to acquire life insurance policies that have little or no market value due to the number of expected years of life expectancy, as is described herein. Acquisition costs of Single Premium Immediate Annuities to provide payments for “fully funded” polices are estimated to be about 7 times the cost of acquiring the polices and are dependent upon age and gender, and somewhat upon state of residence. Those of ordinary skill in the art could readily determine the foregoing acquisition costs.

Terms of Limited Liability Company Distributions Based on Investment Milestones generally vary from transaction to transaction, and may readily be determined by those of ordinary skill in the art. For example, a private company could utilize set amounts of dividend payments, rather than market value, or fluctuation of distributions could be based upon timing of the retirement of debt instruments offered by the Issuer. For a FUND Offering, change in Limited Liability Company distributions could be based upon increases in Net Asset Value. In some Offerings, Investors could be advised of receiving phantom Single Premium Immediate Annuity income during the first few years (providing time to determine whether the Issuer hits pre-specified Investment Milestones before any distributions are made), with no distributions from which to pay taxes. In Offerings with distributions to cover tax liability, in the event that an Insured lives beyond life expectancy assumed in Single Premium Immediate Annuity proceeds, such that the tax basis in Single Premium Immediate Annuity is fully recaptured and, thus, all subsequent Single Premium Immediate Annuity proceeds are taxable as income, the Limited Liability Company or Master Life Insurance Trust could liquidate a portion of its portfolio or reduce death benefits of one or more life insurance policies to assure sufficient funds to pay premiums on life insurance policies, and continue to make distributions to Investors, so that they may pay tax on allocable shares of Single Premium Immediate Annuity proceeds. Alternatively, Offering documents could disclose the risk of potential tax liability from such event, with no offsetting of Limited Liability Company distributions.

### EXAMPLE 2

### FUND Transactions or Direct Participation Program (“FUND”) Investments

Preferably, FUND structures that use a LIBAC^{SM} business system and/or process of the invention will always entail a Limited Liability Company (“LLC”), Limited Partnership (“LP”), or a Delaware Statutory Trust (“DST”) business structure. The FUND will preferably deploy either:
(1) a flow through, full payout distribution business strategy (i.e. a real estate income FUND, an oil and gas FUND, or a life settlement FUND); or
(2) a FUND that strictly invests in publicly traded equities, or some other traded or commonly valued asset, where the Net Asset Value (“NAV”) in the FUND may be tracked by objective standards (e.g. PIPE FUND, currency FUND or FUND of FUNDs).
   A Confidential Private Placement Offering Memorandum is drafted and funds are raised based on the sample terms below.
Offering Amount: $100,000,000 (Closed-end FUND)
Units Offered: By way of the Confidential Private Placement Offering Memorandum, XYZ, Inc. (the “Issuer”) will offer (the “Offering”) on a “best efforts, all or none” basis up to the minimum offering, and a “best efforts” basis thereafter, 10,000 units (the “Units”), with each Unit consisting of:
   one (1) membership interest in the XYZ Fund, LLC (the “FUND”); and
   one (1) membership interest in the XYZ LIBAC^{SM} Fund, LLC (the “LIBAC^{SM} LLC”).
Unit Price: $10,000 per Unit (with a minimum subscription of 10 units or $100,000).
Unit Allocation: Each Unit investment is placed in a securities escrow until the Minimum Offering (discussed below) is reached.
   Once the Minimum Offering is reached:
      40% of the gross funds raised will purchase pro-rata membership interests in the LIBAC^{SM} LLC, and be transferred to a Life Settlement Escrow to fund the purchase of LIBAC^{SM} Assets with a total combined face amount in “Fully Funded” life insurance policies equal to, or greater than, the gross Offering proceeds; and
      60% of the gross funds raised will purchase LLC membership interests in the FUND from which placement agent fees and Offering expenses are paid. (See Placement Agents Compensation below.)

Example
Each Unit investment represents gross proceeds invested of $10,000.
$4,000 (40%) will represent the purchase of one membership interest in the LIBAC^{SM} LLC, creating and owning $10,000 (or more) in total combined “Fully Funded” life insurance face amount in LIBAC^{SM} Assets.
$6,000 (60%) will represent the purchase of one membership interest in the FUND.
The FUND will pay commissions (placement agent fees) and Offering costs of 4% or 10%, depending upon the class of Investor (i.e., institutional or retail), of which the FUND will net $5,600 or $5,000 (56% or 50%, respectively) in Offering proceeds that will be used for FUND investing. Commissions are paid based on the total gross amount raised, not on the amount that is invested in FUND membership interests. Once the FUND meets its pre-determined Investment Milestones (discussed below), a pre-determined portion of LIBAC^{SM} LLC membership interests are transferred to the FUND, and become an asset of the FUND, making the initial Offering costs less dilutive.
Minimum Offering: The Minimum offering amount is $10,000,000 (1,000 Units) from which the FUND would receive $6,000,000, less applicable placement agent fees and Offering expenses.
Maximum Offering: The Maximum offering amount is $100,000,000 (10,000 Units) from which the FUND would receive $60,000,000 less applicable placement agent fees and Offering expenses.
Investment Milestones: It is preferred that FUND structures will deploy either:
   a full distribution FUND strategy; or
   a Net Asset Value tracking FUND strategy,
that will determine when, and if, the FUND has reached its Investment Milestones.
   It is also preferred that each FUND structure will have two milestone benchmarks to be reached, which may vary, and may readily be selected by those of ordinary skill in the art, whereby at each benchmark an automatic transfer of ownership in the LIBAC^{SM} LLC membership interest takes place. However, fewer or additional benchmarks may be employed. Consequently, as each Investment Milestone is reached, the new LIBAC^{SM} LLC ownership percentages will determine LIBAC^{SM} LLC distributions when, and if, the life insurance policies mature. The two FUND structures and their investment milestones/distributions are described below.

I. Full Distribution FUND Structure

This FUND structure will generally distribute to FUND Investors all profits, less FUND expenses, management fees and performance fees, on a quarterly basis.

First Milestone

The first milestone is reached when Investors have received a total return (100%) of their original gross investment (in Units) in cash-on-cash distributions, from the combination of FUND and/or LIBAC^{SM} LLC life insurance policy maturity (death benefit) distributions. Upon the FUND reaching this first milestone, and pursuant to the LIBAC^{SM} LLC operating agreement, 50% of the LLC membership interests in the LIBAC^{SM} LLC are automatically transferred from Investors to the FUND, such that at this milestone mark, the original investors retain 50% of the membership interests in the LIBAC^{SM} LLC, and the FUND owns the other 50%. At this point, distributions from any and all life insurance policy maturities from the LIBAC^{SM} LLC will be distributed one-half to investors and one-half to the FUND, up to and until the second Investment Milestone is reached.

Second Milestone

The second and last milestone is reached when Investors have received a 200% total return of their original gross investment in cash-on-cash distributions from the combination of FUND and/or LIBAC^{SM} LLC life insurance policy maturity (death benefit) distributions. Upon the FUND reaching the second milestone, and pursuant to the LIBAC^{SM} LLC operating agreement, 50% of the remaining LIBAC^{SM} LLC membership interests owned by the Investors (or 25% of the total original issued LLC membership interests) in the LIBAC^{SM} LLC are automatically transferred from Investors to the FUND, such that at this second milestone mark the original Investors retain 25% of the membership interests in the LIBAC^{SM} LLC, and the FUND owns the other 75%. At this point, distributions from any and all life insurance policy maturities from the LIBAC^{SM} LLC will be distributed one-quarter to Investors and three-quarters to the FUND. No further transfer of LIBAC^{SM} LLC membership interests (dilution) would occur after this milestone.

After the FUND reaches its second milestone, two strategies for the FUND may exist for its portion of life insurance policy maturity allocations:
take all of its life insurance policy maturities in cash, and reinvest them in one or more of the FUND's investment strategies; or
take a portion of the life insurance policy maturities in cash, for example 50%, and purchase additional LIBAC^{SM} Assets to be owned out right by the FUND, and to be used in future business structures.

II. Net Asset Value Tracked FUND Structure

This FUND structure will not typically make scheduled cash distributions to FUND Investors. Instead, the FUND's investment performance is tracked by its Net Asset Value growth or decline. If distributions are made, they may be in the form of dividends in cash and/or equities.

First Milestone

The first milestone for this FUND structure is reached when the combination of cash, dividends, and/or equity distributions (which are generally “marked to market” at distribution), LIBAC^{SM} LLC life insurance policy maturity (death benefit) distributions, and the FUND's Net Asset Value is equal to 200% of the total original gross investment (in Units).

Upon the FUND reaching this first milestone, and pursuant to the LIBAC^{SM} LLC operating agreement, 50% of the LLC membership interests in the LIBAC^{SM} LLC are generally automatically transferred from Investors to the FUND, such that at this milestone mark the original Investors retain 50% of the membership interests in the LIBAC^{SM} LLC, and the FUND owns the other 50%. At this point, distributions from any and all life insurance policy maturities from the LIBAC^{SM} LLC will generally be distributed one-half to Investors and one-half to the FUND, up to, and until, the second Investment Milestone is reached.

Second Milestone

The Second, and last, milestone is reached when the FUND, from the combination of cash, dividends, and/or equity distributions (again equities are “marked to market” at distribution), LIBAC^{SM} LLC life insurance policy maturity (death benefit) distributions, and the FUND's Net Asset Value, is equal to 300% of the total original gross investment (in Units).

Upon the FUND reaching this second milestone, and pursuant to the LIBAC^{SM} LLC operating agreement, 50% of the remaining LIBAC^{SM} LLC membership interest owned by the Investors (25% of the total original issued LLC membership interests) are generally automatically transferred from Investors to the FUND, such that at this milestone mark, the original Investors retain 25% of the membership interests in the LIBAC^{SM} LLC, and the FUND owns the other 75%. At this point, distributions from any and all life insurance Policy maturities from the LIBAC^{SM} LLC will generally be distributed one-quarter to investors and three-quarters to the FUND. No further transfer of LIBAC^{SM} LLC membership interests (dilution) would occur after this milestone.

After the FUND reaches its second milestone, two strategies for the FUND may exist for its portion of life insurance policy maturity allocations:
take all of its life insurance policy maturities in cash, and reinvest them in one or more of the FUND's investment strategies; or
take a portion of the life insurance policy maturities in cash, for example 50%, and purchase additional LIBAC^{SM} Assets to be owned out right by the FUND, and to be used in future business structures.
Liquidity Options: The FUND anticipates at least two liquidity options that may be available to investors:
   because the Fund will generally be a closed-end FUND, the FUND will accept indications of interest from FUND Investors interested in buying and/or selling their interests, and on a “best efforts” basis, and the FUND manager will generally be proactive in matching interested sellers and buyers; and/or
   once the FUND has an appropriate and successful operating history, the FUND may plan to register its membership interests to trade publicly, rather than privately.
Investor Suitability: Unless otherwise structured, only Accredited Investors and/or Qualified Institutional Buyers may invest.
Placement Agents: A Placement Agent, such as Capital Growth Resources (El Cajon, Calif.), a wholly owned subsidiary of Capital Growth Planning, Inc. (El Cajon, Calif.), and a FINRA member Broker-Dealer, will generally act as sole Placement Agent for the Offering. However, additional Placement Agents may be employed. The Placement Agent may place Units through other FINRA Broker-Dealers who execute a Selling Agreement with the Placement Agent (“Selling Agents”). The Placement Agent may also act as a Co-Placement Agent if and when deemed to be appropriate and/or properly negotiated.
Placement Agent Compensation: Subject to completion of the Minimum Offering, the FUND will generally pay the Placement Agent either:
   a cash commission of six percent (6%), a cash non-accountable expense fee of two (2%), and a cash wholesaling fee of two percent (2%), for a total of ten percent (10%) for Units acquired by Accredited Investors; or
   for Units placed with Qualified Institutional Buyers, a cash commission of two percent (2%), and a cash unaccountable/wholesaling expense fee of two percent (2%), for a total of four percent (4%).
   There may be situations, or structures, in which the Placement Agent will participate in the FUND's profits and/or equity, and/or equities produced in the FUND's business, upon the FUND reaching its Investment Milestones, and preferably on a negotiated and agreed upon basis. A Placement Agent Agreement may include terms and conditions that govern the foregoing.

### EXAMPLE 3

### Private Investments in Public Entity (“PIPE”) Investments

Insured Private Investments in Public Entity (Insured “PIPE”) structures that use the LIBAC^{SM} business system and/or process of the invention preferably involve either:
an existing public company; or
a private company within a “Go Public” funding structure, such as a funded reverse merger (Public Shell) or a special purpose acquisition company (“SPAC”).
   There may be situations in which a company that has a later stage “go public” formula may use the LIBAC^{SM} business process of the invention if such “go public” plans are clearly defined and approved by the selling syndicate or investor(s). Most transactions will preferably use a cumulative convertible preferred stock for Issuers securities, although in some circumstance the Issuer's Common Stock may be used. Either way, an Investment Milestone will generally be based on a pre-determined market price for the Issuer's Common Stock; hence the requirement for publicly traded shares. The Common Stock conversion value (the value at which the preferred stock converts to Common Stock) of the Issuer's currently, or soon to be, traded Common Stock, will generally vary greatly with each deal structure.

For this example, it is assumed that the Common Stock of XYZ, Inc. has traded (last two months) at or near $0.25 per share. The sample terms below describe the LIBAC^{SM} business process of the invention as it may be structured in an “Insured PIPE” investment offering.
Offering Amount: $10,000,000
Units Offered: By way of a Confidential Private Placement Offering Memorandum (“PPM”), XYZ, Inc. (the “Issuer”) will offer (the “Offering”) on a “best efforts, all or none” basis up to the minimum offering and a “best efforts” basis thereafter, 1,000,000 units (the “Units”), with each Unit consisting of:
   one (1) share of Series A 6% cumulative convertible Preferred Stock, par value $0.001 per share (the “Preferred Shares”); and
   one (1) membership interests in the XYZ LIBAC^{SM} Fund, LLC (the “LIBAC^{SM} LLC”).
Unit Price: $10.00 per Unit (minimum subscription is 1,000 units or $10,000).
Unit Allocation: Each Unit investment is placed in a securities escrow until the Minimum Offering is reached ($1,000,000 or 100,000 Units). Once the Minimum Offering is reached, for each Unit sold (at $10.00 per Unit):
   $6.00 will purchase one (1) Preferred Share from the Issuer; and
   $4.00 will purchase one (1) membership interest in the LIBAC^{SM} LLC;
   each respectively representing the Investor's basis in the two securities.
   Said another way, once the Minimum Offering is reached, $600,000 will purchase 100,000 Preferred Shares, and $400,000 will purchase 100,000 Membership Interests with the proceeds transferred to a Life Insurance Settlement Escrow to fund the purchase of LIBAC^{SM} Assets with a total combined face amount in “Fully Funded” life insurance policies equal to or greater than the gross Offering proceeds. Offering expenses and commissions are paid by the Issuer from the securities escrow, based on the gross dollars raised.
Minimum Offering: The Minimum offering amount is $1,000,000 (100,000 Units) from which the Issuer would receive $600,000, less placement agent fees and offering expenses.
Maximum Offering: The Maximum offering amount is $10,000,000 (1,000,000 Units) from which the Issuer would receive $6,000,000, less placement agent fees and offering expenses.
The Preferred Shares: Each share of Series A Preferred Stock is convertible into 40 shares of the Issuer's common stock (“the Common Stock”), or a conversion price of $0.25, based on the $10.00 Unit purchase price.
   The Preferred Shares will automatically convert at the same conversion rate any time six months after the final close of the Offering (to allow for the 6 month Rule 144 tacking period to expire) and at such time as Issuer's Common Stock has traded at a closing bid price of $0.75 per share for 20 or more consecutive trading days (the “Investment Milestone”). Before the automatic conversion takes place, the Issuer has the right to redeem the Preferred stock at $10.00 per share (plus cumulative dividends) if, and only if, the Investors holding the Preferred Shares fail to exercise their voluntary conversion right within 10 business days of certified notice of the redemption. Anytime Preferred Shares are converted or redeemed (on a voluntary basis or not), the conversion or redemption triggers a pro-rata transfer in LIBAC^{SM} LLC membership interests by the Investor to the Issuer equal to that percentage of ownership being converted or redeemed.
   In all situations as described above in which the Issuer becomes the owner of LIBAC^{SM} LLC membership interests, those interests will preferably be subject to a Repurchase Agreement (discussed hereinbelow), generally in favor of the Patent Holder and preferably as a term of a patent licensing agreement between the Issuer and the Patent Holder.
   All life insurance death benefits (LIBAC^{SM} Asset maturities) are preferably “irrevocably” distributed to the LIBAC^{SM} LLC members, as maturities occur, meaning that the Issuer will not receive any such distributions until the Issuer meets one or more of its Investment Milestones (discussed below). The prospect of losing the benefit of possible life insurance policy distributions and/or cash from the Patent Holder, via a repurchase of LIBAC^{SM} LLC membership interests, should make the Issuer more attentive (provide incentives) to reaching its Investment Milestone or redeeming Preferred Shares as soon as possible.
Investment Milestones: In an “Insured PIPE” structure, the Portfolio of LIBAC^{SM} Assets will generally provide PIPE Investors with an insured, bankruptcy-proof “collateral” back-stop of “Fully Funded” senior Life Settlement Insurance Policies with total combined face values equal to, or more than, the total amount invested in the Offering, providing protection against a loss of principal if the Issuer's business plans fail to produce the expected results, as reflected in the market pricing of its traded Common Stock. Essentially, and in most circumstances, the PIPE Investors are insured that they will receive no less than the amount that they originally invested in the transaction as a result of the LIBAC^{SM} Assets.
   A LIBAC^{SM} “Insured PIPE” structure generally provides Investors with protection against loss of investment principal up to and/or until one of the following Investment Milestones are met:
      the Issuer redeems the Preferred Shares (plus cumulative dividends);
      the Investors voluntarily convert their Preferred Shares to Common Stock; and/or
      the Issuer's Common Stock trades at a closing bid price of $0.75 per share or more for 20 consecutive trading days (the “Common Stock Price Threshold”), at which point each Preferred Share automatically converts into 40 shares of the Issuer's Common Stock.
   For the first two Investment Milestones, membership interests in the LIBAC^{SM} LLC generally are transferred to the Issuer in the proportion to which the Issuer redeems Shares, or the investors voluntarily convert their Shares to Common Stock.
   The last Milestone, pursuant to the terms of the LIBAC^{SM} LLC Operating Agreement, generally involves an automatic conversion of any and all outstanding Preferred Shares, and the transfer of all outstanding membership interest in the LIBAC^{SM} LLC to the Issuer.
Repurchase Agreement: The Patent Holder, preferably pursuant to the terms of a patent licensing agreement, will generally have, at its option, the right to purchase any and all Membership Interests that convert to the Issuer at any time up to 180 days from the time the Issuer becomes the sole Member of the Limited Liability Company (LLC) by achieving one or more of the Investment Milestones listed above.
Investor Suitability: Unless otherwise structured, only Accredited Investors, as defined in Rule 501 of Regulation D, promulgated under Section 4(2) of the Securities Act of 1933, as amended, and Qualified Institutional Buyers, as defined in Rule 144A, promulgated under the Securities Act of 1933, may generally invest.
Placement Agents: A Placement Agent, such as Capital Growth Resources, a FINRA member Broker-Dealer, will generally act as sole Placement Agent for the Offering. However, additional Placement Agents may be employed. The Placement Agent may place Units through other FINRA Broker-Dealers who execute a Selling Agreement with the Placement Agent (“Selling Agents”). The Placement Agent may also act as a Co-Placement Agent if and when deemed to be appropriate and/or properly negotiated.
Placement Agent Compensation: Subject to completion of the Minimum Offering, the Issuer will generally pay the Placement Agent either:
   a cash commission of six percent (6%), a cash non-accountable expense fee of two (2%), and a cash wholesaling fee of two percent (2%), for a total of ten percent (10%) for Units acquired by Accredited Investors; or
   for Units placed with Qualified Institutional Buyers, a cash commission of two percent (2%), and a cash unaccountable/wholesaling expense fee of two percent (2%), for a total of four percent (4%).
There may be situations, or structures, in which the Placement Agent will participate in the profits and/or equity, upon the Issuer reaching one or more Investment Milestones, and preferably on a negotiated and agreed upon basis. A Placement Agent Agreement may include terms and conditions that govern the foregoing.
In most situations or structures, the Placement Agent will require three-year warrant coverage in the range of from about 10% to about 20% of the total shares of Common Stock to be issued to Investors, either directly or based on the amount of Common Stock after a full conversion of Preferred Stock to Common Stock, and at an exercise price equal to the Preferred Stock conversion price, in this sample term sheet having an exercise price of twenty-five cents ($0.25).
This and other terms are typically different with each transaction, and can be readily determined by those of ordinary skill in the art. Also, it is preferable that with each transaction, the deal points and structure are pre-negotiated and set forth in a Placement Agent Agreement before the Offering Memorandum is drafted.

### EXAMPLE 4

### Note or DEBT Investments/DEBT Financing (Private and/or Public Companies)

Debt structures that use the LIBAC^{SM} business system and/or process of the invention (i.e., LIBAC^{SM} debt financing structures) preferably use notes (lending) having:
a minimum of about fifteen (15) year maturity for secured, amortized loan transactions; and
a minimum of about twenty-five (25) year maturity for unsecured, interest only, loan transactions;
   with the LIBAC^{SM} Assets serving to self-liquidate the note principal. The note holders are the Investors.

Offerings ranging from about $10,000,000 to about $100,000,000 are preferred, and it is preferred that the portfolio of LIBAC^{SM} Assets hold from about 100 to about 200 policies to function efficiently, requiring investments preferably ranging from about $50,000,000 to about $100,000,000.

The reason for the preferred longer maturities (from about 15 to about 25 years) is that the formation of LIBAC^{SM} Assets requires the use of life insurance policies with life expectancies (“LE”) preferably of from about 12 to about 18 years, with preferably an average life expectancy of about 15 years. This life insurance policy type, and the use of the LIBAC^{SM} business system and process, provides an efficient “self-liquidating” mechanism for a partial or complete pay down of the debt principal as the life insurance policies (the “LIBAC^{SM} Assets”) held in the LIBAC^{SM} LLC mature.

15 Year Note Maturity Structure (Secured Note)

For the shorter 15-year secured note maturity structure, one typically should expect about 50% or more of the LIBAC^{SM} Assets to have matured by the 15^{th} year, leaving about 50% or less in life insurance policies to mature over the following 10 years. This lending scenario requires the shortfall (50%) in principal repayment to be covered by additional security (such as real estate or plant and equipment, that may be purchased in the transaction) and have a level of principal amortization through periodic loan payments to retire that portion of the principal not expected to be paid through the self-liquidating feature of the LIBAC^{SM} Assets. Thus, the note is typically expected to be paid in its entirety at maturity through regular periodic payments by the Issuer and through LIBAC^{SM} LLC Policy death benefit maturity distributions. If interest only payments, with a balloon payment due at maturity, is deployed, note maturities shorter than about 25 years will generally only be considered if the Issuer demonstrates its ability to repay that portion of the note principal that projections reflect will not be paid through life insurance policy maturities, and the issuer secures the note with assets (or those to be purchased in the transaction) having a value at loan maturity of at least about equal to the projected balloon payment due on maturity.

25 Year Note Maturity Structure (Unsecured Note)

A more simple approach may be structured using an unsecured, interest only, twenty-five (25) year note maturity structure, whereby the loan is designed to generally be completely self-liquidating by the maturity date.

A subsidiary of the Patent Holder (or other entity) that is preferably sophisticated in the life insurance market can purchase from Insureds Special Purpose Life Insurance Policies that will, under contract, mature at age 100, even if the Insured lives beyond age 100. Purchasing these Special Purpose Life Insurance Policies where all Insureds are ages 75 or older generally guarantees that all life insurance polices will mature during the 25 year term of the note, making a portfolio of these LIBAC^{SM} life insurance policy Assets ideal for a self-liquidating note structure. For example, as life insurance policies mature over the 25-year period, the net death benefits generally are distributed to note holders (the Investors) and applied as direct principal pay downs, thereby reducing future periodic interest payments. Pro formas indicate that the cost with this structure is typically significantly less than traditional commercial loan costs for 25 year note structures, making this LIBAC^{SM} debt financing structure highly useful in commercial lending situations.

This system and method of debt financing using the LIBAC^{SM} business system and/or process is generally best suited for commercial projects, real estate transactions, or other asset acquisitions involving assets with a long useful life. Also, for Public companies, the note may feature a conversion to Common Stock as a means of retiring the note for situations that allow such a structure. The following sample terms describe the LIBAC^{SM} business system and process of the invention as used in a $50,000,000 unsecured debt financing (Private company) offering transaction using a twenty-five (25) year self-liquidating maturity date and structure:
Offering Amount: $50,000,000
Securities Offered: XYZ, Inc. (the “Issuer”) forms XYZ LIBAC^{SM}, LLC, a limited liability company (the “LIBAC^{SM} LLC”) that will offer (the “Offering”) for sale all of its new-issue equity membership interests to Investors on a “best efforts, all or none” basis up to the minimum offering, and a “best efforts” basis thereafter.
   The LIBAC^{SM} LLC places 40% of the Gross Offering Proceeds into a life insurance settlement escrow to acquire LIBAC^{SM} Assets, using Special Purpose Life Insurance Policies having cumulative face values equal to, or greater than, the Gross Offering Amount, to provide the self-liquidating feature for the Issuer's note. The note will require quarterly “interest only” payments.
   With the balance of Gross Offering Proceeds, the LIBAC^{SM} LLC pays Offering expenses, and funds the loan to the Issuer.
   The intent of the Offering is to fund a loan to the Issuer and acquire LIBAC^{SM} Assets as a means of assuring Investors at least a return of their invested principal (and preferably full payment of the note with all interest). Thus, the Issuer, in addition to the LIBAC^{SM} LLC, is deemed to be the Issuer of the securities for purposes of federal and state securities laws and full disclosure of the Issuer, its business plans, attendant risks, the Issuer's financials, and all of the terms of the debenture must be disclosed in the Offering Memorandum. In some cases, investor warrants in the Issuer may be included as part of a Unit offering consisting of the LIBAC^{SM} LLC membership interests and the Issuer's investor warrants.
Membership Interest Price: $100.00 per membership interest (minimum investment is $50,000).
Minimum Offering: The Minimum Offering amount is $10,000,000 from which the Issuer would receive funds in the approximate amount of $6,000,000 (less applicable placement agent fees and Offering expenses) in exchange for its note payable to the LIBAC^{SM} LLC with a principal balance of $10,000,000.
Maximum Offering: The Maximum offering amount is $50,000,000 from which the Issuer would receive funds in the approximate amount of $30,000,000 (less applicable placement agent fees and Offering expenses) in exchange for its note payable to the LIBAC^{SM} LLC with a principal balance of $50,000,000.
Note Terms: The initial principal balance of the debenture equals the gross Offering proceeds, even though the actual funds received by the Issuer are approximately 60% of the gross Offering proceeds, less placement agent fees and Offering costs.
   The debenture matures in twenty-five years, with quarterly interest payments, in arrears, calculated with 6% simple interest. (This interest rate is just an example. Actual interest rates will generally be determined on a transaction by transaction basis based upon the credit market, the credit worthiness of the Issuer, the type of assets being purchased (if applicable), and other additional appropriate consideration, as is known by those of ordinary skill in the art.)
   Pursuant to the terms of the debenture, all net death benefits received by the LIBAC^{SM} LLC are distributed to Investors and credited towards sums due under the debenture first to collection costs and late charges, if any, then to accrued interest, if any, and then to principal.
   In the event of a default by the Issuer (most likely a failure to cure any late payment of interest), the LIBAC^{SM} LLC would generally be able to sue the Issuer for all sums owed under the debenture (including the principal balance under an acceleration clause), less the current Net Asset Value of the LIBAC^{SM} Assets, as determined by three qualified business valuation appraisers, with one appraiser chosen by the Issuer, one appraiser chosen by the LIBAC^{SM} LLC, and the third appraiser chosen by the other two appraisers. Alternatively, in the case of an uncured default by the Issuer, members could vote to liquidate the LIBAC^{SM} Assets, with sale proceeds reducing the balance owed on the debenture, and then commence legal proceedings against the Issuer to recover the balance owed.
Operating Agreement: An 80% super-majority (by financial interest) of investors, in their capacity as LIBAC^{SM} LLC members, may amend the LIBAC^{SM} LLC Operating Agreement. However, to assure that the Issuer receives the benefit of the self-liquidating aspect of the LIBAC^{SM} Assets, members may only vote to sell all or a portion of LIBAC^{SM} Assets when, and if, the Issuer fails to cure a default within a stated cure period.
Investor Suitability: Unless otherwise structured, generally only Accredited Investors, as defined in Rule 501 of Regulation D, promulgated under Section 4(2) of the Securities Act of 1933, as amended, and Qualified Institutional Buyers may invest.
Placement Agents: A Placement Agent, such as Capital Growth Resources, a FINRA member Broker-Dealer, will generally act as sole Placement Agent for the Offering. However, additional Placement Agents may be employed. The Placement Agent may place Units through other FINRA Broker-Dealers who execute a Selling Agreement with the Placement Agent (“Selling Agents”). The Placement Agent may also act as a Co-Placement Agent if and when deemed to be appropriate and/or properly negotiated.
Placement Agent Compensation: Subject to completion of the Minimum Offering, the LIBAC^{SM} LLC will generally pay the Placement Agent either:
   a cash commission of six percent (6%), a cash non-accountable expense fee of two (2%), and a cash wholesaling fee of two percent (2%), for a total of ten percent (10%) for Units acquired by Accredited Investors; or
   for Units placed with Qualified Institutional Buyers, a cash commission of two percent (2%), and a cash unaccountable/wholesaling expense fee of two percent (2%), for a total of four percent (4%).
There may be situations, or structures, in which the Placement Agent will receive warrants in the Issuer's equity securities on a negotiated and agreed upon basis. Because debt financing generally does not provide an easy mechanism for the Patent Holder (or other entity) to re-acquire LIBAC^{SM} LLC membership interest upon the Issuer reaching certain Investment Milestones found in other types of LIBAC^{SM} structures, a patent licensing agreement may include terms and conditions for the Patent Holder to acquire warrants to purchase the issuer's securities.

### EXAMPLE 5

### Combination DEBT Financing Structure with FUND or PIPE LIBAC^{SM} Structure (Hybrid Structure)

It is possible to incorporate a LIBAC^{SM} Debt Financing structure with either a FUND or Insured PIPE LIBAC^{SM} financing in one Offering transaction. In such a situation, the Debt portion of the Offering generally would mirror the structure outlined hereinabove for debentures, and the equity portion would mirror the FUND or PIPE financing structure, and be reflected in the Issuers sale of its securities (Preferred or Membership interests) as part of the “Units” being offered. This is referred to as a “Hybrid structure,” and generally requires an Issuer who is Public and has special project funding needs. Each Hybrid structure is typically designed on a case-by-case basis.

While the present invention has been described herein with specificity, and with reference to certain preferred embodiments thereof, those of ordinary skill in the art will recognize numerous variations, modifications and substitutions of that which has been described which can be made, and which are within the scope and spirit of the invention. For examples:
the investment structures that are described herein may have fewer or more Investment Milestones, such as one, two, three, four, five, six, seven, eight, nine, ten and so forth, or different milestones, depending upon investment objectives, as would be known by a person of ordinary skill in the art;
unless stated otherwise, all of the percentages that are described herein generally may vary widely, and range from about 1 to about 100 percent, such as one, two, three, four, five, six, seven, eight, nine, ten, fifteen, twenty, twenty-five, thirty, thirty-five, forty, forty-five, fifty, fifty-five, sixty, sixty-five, seventy, seventy-five, eighty, eighty-five, ninety, ninety-five and one hundred, and the like;
the Minimum Offering and Maximum Offering that are described herein generally may vary widely according to investment objectives, as would be known by a person of ordinary skill in the art;
Unit purchase, redemption prices of Common Stock, Preferred Stock, conversion prices of Preferred Stock to Common Stock and/or other investment vehicles as described herein generally may vary widely according to investment objectives, as would be known by a person of ordinary skill in the art;
Redemption periods, during which Issuers are permitted to redeem Common Stock, Preferred Stock and/or other investment vehicles as described herein generally, and other time periods, may vary widely according to investment objectives, as would be known by a person of ordinary skill in the art.
   It is intended that all of these modifications and variations be within the scope of the present invention as described and claimed herein, and that the invention be limited only by the scope of the claims which follow, and that such claims be interpreted as broadly as is reasonable.

Throughout this document, various books, patents, published patent applications, web sites, laws and/or other publications have been cited. The entireties of each of these books, patents, published patent applications, web sites, laws and other publications are hereby incorporated by reference herein.

What is claimed is:

1. An investment system that permits one or more investors to invest in a business entity, with potential returns on their investment while minimizing a risk of a loss of invested capital, comprising:
(a) one or more in force life insurance policies provided by one or more Insureds ranging from about 65 to about 85 years in age that insure the lives of the Insureds, or their spouses, and that have one or more beneficiaries, wherein the beneficiaries are persons who, on the date of an issuance of the life insurance policies, have an insurable interest in the lives of the Insureds or their spouses;
(b) an instrument governing a formation, or provision, of a Pass Through Business Entity, optionally formed by an Issuer;
(c) an Offering Memorandum for a securities Offering in which the following are offered for sale to one or more Investors in exchange for a payment by the Investors of investment funds:
(1) by the Pass Through Business Entity of ownership interests in the Pass Through Business Entity, wherein a portion of the total investment funds invested by the Investors is paid to the Pass Through Business Entity for such ownership interests, and wherein such portion is an amount that is required to acquire one or more LIBAC^{SM} Assets having a combined face value that is similar to, equal to, or in excess of, the total amount of the invested funds; and
(2) by the Issuer, one or more classes of “equity interests,” “debt securities,” or a combination of “equity interests” and “debt securities,” wherein a portion of the total investment funds invested by the Investors is paid to the Issuer for such “equity interests,” “debt securities,” or combination of “equity interests” and “debt securities,” and wherein such portion is a remaining net balance of the total investment funds paid by the Investors;
(d) an agreement in which the Insureds agree to:
(1) sell their interests in the LIBAC^{SM} Assets; and
(2) use a portion of funds provided to them by the Pass Through Business Entity to purchase one or more Single Premium Immediate Annuities, wherein each Insured is the measuring life of the annuity(ies) such Insured purchases and is sole annuitant of the annuity(ies) and the beneficiary of the annuity(ies), or each Insured is the measuring life of the annuity(ies) and one or more other entities to be acquired by the Pass Through Business Entity are the beneficiary(ies), wherein the Single Premium Immediate Annuities generate one or more annuity payments in amounts that are sufficient to pay:
(i) premiums that become due for the life insurance policies,
(ii) administrative expenses;
(iii) incidental taxes related to Single Premium Immediate Annuity income; or
(iv) any combination of two or more of (i), (ii) and (iii);
and wherein the Single Premium Immediate Annuities terminate upon the deaths of the Insureds, or at the related life insurance policy maturity date if earlier than the death of the Insured whose life is the measuring life for both the life insurance policy and the related Single Premium Immediate Annuity;
(e) one or more Single Premium Immediate Annuities, wherein such annuities are purchased using funds advanced to the Insureds by the Pass Through Business Entity;
(f) LIBAC^{SM} distributions comprising:
(1) death benefits under the life insurance policies, wherein the life insurance policies have a total (combined) face value that is similar to, equal to, or in excess of, the total amount of funds invested by the Investors in the securities Offering; and
(2) annuity payments made under the one or more Single Premium Immediate Annuities that are similar to, equal to, or in excess of, the amount of money that is required to pay:
(i) premiums due for the life insurance policies;
(ii) administrative expenses;
(iii) taxes due on the income portion of Single Premium Immediate Annuity payments; or
(iv) any combination of two or more of (i), (ii) and (iii);
wherein the LIBAC^{SM} distributions are provided to the Pass Through Business Entity, and provide funds for distribution to each Investor for a repayment of a portion or all of the principal amount of the Investor's investment made pursuant to the Offering, and wherein the Issuer, upon achieving one or more pre-specified Investment Milestones in connection with the “equity interests,” “debt securities,” or combination of “equity interests” and “debt securities” may, optionally:
(i) be entitled to collect a portion of the LIBAC^{SM} distributions, such that it may book an aliquot interest in the Pass Through Business Entity as an asset on a balance sheet; and
(ii) upon the deaths of one or more of the Insureds, be provided with a portion or all of the death benefits provided by the life insurance policies.

2. A system of claim 1, wherein the business entity is a public or private, start up, early stage, high growth, or cash poor entity, or otherwise in need of a capital infusion through a moderate to high risk investment, whose primary business is unrelated to the Life Insurance Settlement market.

3. A system of claim 1, wherein the business entity is a FUND.

4. A system of claim 1, wherein the business entity is a FUND of FUNDS.

5. A system of claim 1, wherein the business entity is seeking PIPE Investment.

6. A system of claim 1, wherein the business entity is seeking an Equity Investment

7. A system of claim 1, wherein the business entity is seeking a Debt Investment.

8. A system of claim 1, wherein the business entity is seeking a Hybrid Investment.

9. A system of claim 1, wherein the portion of the total investment funds that is paid to an Issuer, and is not allocated to the Pass Through Business Entity, by one or more Investors for new issue “equity interests” and/or “debt securities” is a majority of the total investment funds.

10. A system of claim 1, wherein the portion of the total investment funds that is paid to an Issuer, and is not allocated to the Pass Through Business Entity, by one or more Investors for new issue “equity interests” and/or “debt securities” ranges from about 60% to about 70% after the allocation to the Pass Through Business Entity.

11. A system of claim 1, wherein the portion of the total investment funds that is paid to a Pass Through Business Entity by one or more Investors for “membership interests” is a minority of the total investment funds.

12. A system of claim 1, wherein the portion of the total investment funds that is paid to a Pass Through Business Entity by one or more Investors for “membership interests” ranges from about 25% to about 40%.

13. A system of claim 1, wherein the portion of the total investment funds that is paid to a Pass Through Business Entity by one or more Investors for “membership interests” is about 38%.

14. A system of claim 1, wherein about 40% of the funds raised preferably go to a Pass Through Business Entity to purchase Fully-Funded LIBAC^{SM} Assets similar to, equal to, or more than, the total amount of money raised.

15. A system of claim 1, wherein about 60% of the funds raised is invested in the Issuer's securities.

16. A system of claim 1, wherein the life insurance policies are non-variable.

17. A system of claim 1 wherein the life insurance policies are variable.

18. A system of claim 1, wherein the life insurance policies have an expired contestability period.

19. A system of claim 1, wherein the life insurance policies are held on Insureds ranging in age from about 70 to about 80 years.

20. A system of claim, wherein the life insurance policies are senior life insurance policies with a life expectancy of more than about 12-14 years.

21 A system of claim 1, wherein the LIBAC^{SM} Assets carry an average life expectancy of approximately 15 years.

22. A system of claim 1, wherein from about 50% to about 85% of the life insurance polices mature in from about 12 to about 14 years, or sooner.

23. A system of claim 1, wherein the life insurance policies are settled.

24. A system of claim 1, wherein the death benefits of the life insurance policies are similar to, equal to, or in excess of, the total amount of the funds invested.

25. A system of claim 1, wherein the Insured(s) place the life insurance policies to be settled in a Revocable Life Insurance Trust.

26. A system of claim 1, wherein the Insured(s) places one or more of his or her life insurance policies to be settled in a Revocable Life Insurance Trust.

27. A system of claim 1, wherein the Revocable Life Insurance Trust becomes the sole owner and sole beneficiary of the life insurance policies.

27. A system of claim 1, wherein the beneficiary or beneficiaries of the Revocable Life Insurance Trust are individuals who have or had an insurable interest in the life of the Insured.

29. A system of claim 1, wherein an Insured is contractually obligated to fund the Revocable Life Insurance Trust by obtaining and contributing to the trust one or more Single Premium Immediate Annuities using the Insured's life as the measuring life of the annuity.

30. A system of claim 1, wherein the face value and death benefit of each life insurance policy ranges from about $100,000 to about $5,000,000.

31. A system of claim 1, wherein the face value and death benefit of each life insurance policy ranges from about $250,000 to about $2,000,000.

32. A system of claim 1, wherein the face value and death benefit of each life insurance policy ranges from about $500,000 to about $1,000,000.

33. A system of claim 1, wherein the life insurance policies are term life insurance policies that may at any point be converted to whole life or universal life insurance policies.

34. A system of claim 1, wherein the classes of securities being offered are new issue “equity interests,” “debt securities,” or a combination of “equity interests” and “debt securities.”

35. A system of claim 1, wherein the classes of securities being offered are already issued classes of “equity interests,” “debt securities,” or a combination of “equity interests” and “debt securities.”

36. A system of claim 1, wherein the Investors are assured of receiving at least a total return (100%) of their original gross investment.

37. A system of claim 1, wherein the Investors are assured of receiving an additional return on their investment.

38. A system of claim 1, wherein the Investors are assured of making a substantial return on their investment.

39. A system of claim 1, wherein the risk of loss of the Investors' investment is very low.

40. A system of claim 1, wherein the risk of loss of the Investors' investment is low.

41. A system of claim 1, wherein the risk of loss of the Investors' investment is less than about 25%.

42. A system of claim 1, wherein the risk of loss of the Investors' investment is less than about 20%.

43. The system of claim 1, wherein the risk of loss of the Investors' investment is less than about 15%.

44. The system of claim 1, wherein the risk of loss of the Investors' investment is less than about 10%.

45. The system of claim 1, wherein the risk of loss of the Investors' investment is less than about 5%.

46. The system of claim 1, wherein the risk of loss of the Investors' investment is less than about 1%.

47. A system of claim 1, wherein a Revocable Life Insurance Trust is not employed, and wherein the Insured acquires a Single Premium Immediate Annuity, and the Insured's life insurance policy and Single Premium Immediate Annuity are purchased by the Master Life Insurance Trust directly.

48. A system of claim 1, wherein a Revocable Life Insurance Trust is not employed, and wherein the Insured acquires a Single Premium Immediate Annuity, and the Insured's life insurance policy and Single Premium Immediate Annuity are acquired directly by a Pass Through Business Entity or through a Revocable Life Insurance Trust without the intervening step of the Master Life Insurance Trust acquiring the life insurance policy and Single Premium Annuity directly or through a Revocable Life Insurance Trust.

49. The system of claim 1, wherein proceeds from the mechanism used to assure the Investors' investment eliminates double taxation of such proceeds.

50. A system of claim 1, wherein the Pass Through Business Entity is formed by an Issuer.

52. A system of claim 1, wherein the Master Life Insurance Trust is formed by the Pass Through Business Entity.

53. A system of claim 1, wherein a non-equity manager of the Pass Through Business Entity is the sole manager of the Pass Through Business Entity.

54. A system of claim 1, wherein the Investors become the sole non-manager equity members of the Pass Through Business Entity.

55. A system of claim 1, wherein the Pass Through Business Entity is a Limited Liability Company, a General Partnership, a Limited Partnership, an S Corporation, a Simple Trust, a Regulated Investment Company, a Real Estate Investment Trust or a Delaware Statutory Trust.

56. A system of claim 1, wherein the Pass Through Business Entity is a Limited Liability Company.

57. A system of claim 1, wherein the Pass Through Business Entity is a partnership.

58. A system of claim 1, wherein the partnership is managed by a sole general partner.

59. A system of claim 1, wherein the Single Premium Immediate Annuities terminate upon the death of the Insureds.

60. A system of claim 1, wherein the Single Premium Immediate Annuities terminate at the related life insurance policy maturity date, when it is earlier than the death of the Insured.

60. A system of claim 1, wherein the lump sum payment for each Single Premium Immediate Annuity ranges from about $22,000 to about $1,100,000.

62. A system of claim 1, wherein the lump sum payment for each Single Premium Immediate Annuity ranges from about $55,000 to about $440,000.

63. A system of claim 1, wherein the lump sum payment for each Single Premium Immediate Annuity ranges from about $110,000 to about $220,000.

64. A system of claim 1, wherein annuity payments are made quarterly, annually or at any time between quarterly and annually.

65. A system of claim 1, wherein the Revocable Life Insurance Trusts are governed by trust agreements executed by the Insureds or the Insureds' spouses.

66. A system of claim 1, wherein the Revocable Life Insurance Trusts are the sole owners and sole beneficiaries of the life insurance policies.

67. A system of claim 1, wherein the Pass Through Business Entity is a sole beneficiary of the Master Life Insurance Trust.

68. A system of claim 1, wherein the Master Life Insurance Trust is irrevocable.

69. A system of claim 1, wherein the Master Life Insurance Trust is revocable.

70. A system of claim 1, wherein the Master Life Insurance Trust, upon formation, elects to be treated as a partnership for tax reporting purposes.

71. A system of claim 1, wherein the Master Life Insurance Trust is funded by the Pass Through Business Entity using a minority portion of the total funds invested by the Investors.

72. A system of claim 1, wherein the Investment Milestones are set forth in a Pass Through Business Entity Operating Agreement or Offering document.

73. A system of claim 1, wherein the Issuer is entitled to collect a portion of the LIBAC^{SM} distributions as a result of achieving one or more pre-specified Investment Milestones.

74. An investment system that permits one or more investors to invest in a business entity, with potential returns on their investment while minimizing a risk of a loss of invested capital, comprising:
(a) one or more Revocable Life Insurance Trusts provided by one or more Insureds ranging from about 65 to about 85 years in age for which the Insureds, or their spouses, are the Grantor(s), wherein the Revocable Life Insurance Trusts contain one or more in force, non-variable or other life insurance policies that insure the lives of the Insureds, or of their spouses, and that have one or more beneficiaries, and wherein the beneficiaries of the Revocable Life Insurance Trusts are individuals who, on the date of the issuance of the non-variable life insurance policies, have or had an insurable interest in the lives of the Insureds, or their spouses;
(b) an instrument governing a formation, or provision, of a Pass Through Business Entity, optionally by an Issuer;
(c) a Master Life Insurance Trust, optionally formed by the Pass Through Business Entity, wherein this trust is funded by the Pass Through Business Entity, optionally using a minority portion of the total funds invested by the Investors;
(d) an Offering Memorandum governing a public or private securities Offering in which the following are offered for sale to one or more Investors in exchange for a payment by the Investors of investment funds:
(1) by the Pass Through Business Entity of new-issue “membership interests” in the Pass Through Business Entity, wherein the portion of the total investment funds invested by the Investors is paid to the Pass Through Business Entity for such “membership interests,” and wherein such portion, optionally, is a minority of the total investment funds paid by the Investors, and is an amount required to acquire one or more LIBAC^{SM} Assets having a face value similar to, equal to, or in excess of, the total amount of the invested funds; and
(2) by the Issuer of one or more classes of “equity interests,” “debt securities,” or a combination of “equity interests” and “debt securities,” wherein a portion of the total investment funds invested by the Investors is paid to the Issuer for such “equity interests,” “debt securities,” or combination of “equity interests” and “debt securities,” is, optionally, a majority and remaining net balance of the total investment funds paid by the Investors;
(e) an agreement in which the Insureds of the Revocable Life Insurance Trusts agree to:
(1) sell their trust powers; and
(2) use a portion of the funds provided to them by the Master Life Insurance Trust to cause the Revocable Life Insurance Trust to purchase one or more Single Premium Immediate Annuities whose measuring life is the same measuring life as the life insured under the life insurance policy(ies) owned by the Revocable Life Insurance Trust;
(f) one or more Single Premium Immediate Annuities, wherein each Insured is the measuring life of the related annuity(ies), and the beneficiaries of the annuities are the Revocable Life Insurance Trusts, wherein the Single Premium Immediate Annuities generate one or more annuity payments in amounts that are sufficient to pay:
(i) premiums that become due for the life insurance policies,
(ii) the fees for the trustee(s) of the Revocable Life Insurance Trusts and Master Life Insurance Trust;
(iii) Pass Through Business Entity administrative expenses;
(iv) any income tax that becomes due on that portion of proceeds of the annuity that are taxable; or
(v) any combination of any two or more of (i), (ii), (iii) and (iv);
wherein the Single Premium Immediate Annuities terminate upon the death of the Insureds, or at the related life insurance policy maturity date if earlier than the death of the Insured;
(g) an instrument in which the Master Life Insurance Trust acquires trust powers to control one or more Revocable Life Insurance Trusts, and have the grantor Master Life Insurance Trust named as a beneficiary of the Revocable Life Insurance Trusts and, thereby, obtain a right to receive LIBAC^{SM} distributions;
(h) LIBAC^{SM} distributions comprising:
(1) death benefits under the life insurance policies owned by each Revocable Life Insurance Trust, wherein the life insurance policies have a total (combined) face value that is similar to, equal to, or in excess of, the total amount of funds invested by the Investors in the Offering; and
(2) annuity payments made under one or more Single Premium Immediate Annuities (each a “SPIA”) that are similar to, equal to, or in excess of, the amount of money that is required to pay:
(i) premiums due for the life insurance policies;
(ii) trust administrative expenses;
(iii) Pass Through Business Entity administrative expenses;
(iv) taxes due on the income portion of Single Premium Immediate Annuity payments; or
(v) a combination of any two or more of (i), (ii), (iii) and (iv);
wherein the LIBAC^{SM} distributions provide funds for distribution to each Investor for a repayment of the principal amount of the Investor's investment made pursuant to the Offering, and wherein the Issuer may, optionally, be entitled to collect a portion of the LIBAC^{SM} distributions, depending upon the Issuer achieving one or more pre-specified Investment Milestones in connection with the “equity interests,” “debt securities,” or a combination thereof, issued by the Issuer as part of the Offering;
(i) an instrument in which the grantors of the Revocable Life Insurance Trusts are assigned all rights to amend, change and/or revoke the Revocable Life Insurance Trusts, and all rights and powers to sell, convey, transfer and/or assign trust powers to the Master Life Insurance Trust, through which the written agreements governing the Revocable Life Insurance Trusts are amended to:
(1) optionally, name the Master Life Insurance-Trust as the sole beneficiary of the Revocable Life Insurance Trusts;
(2) optionally, name a new trustee(s) of the Revocable Life Insurance Trusts, wherein the new trustee(s) are designated by the Master Life Insurance Trust;
(3) provide that the beneficiary has the power to amend, change and/or revoke the Revocable Life Insurance Trust in the future; and
(4) provide that the beneficiary has the right and power to sell, convey, transfer and/or assign trust powers in the future;
(j) an instrument in which the Insureds assign all of their rights and powers to amend, change, revoke and/or supplement trust agreements that govern the Revocable Life Insurance Trusts, and the right and power to sell, convey, transfer and/or assign trust powers, in exchange for a payment to the Insureds by the Master Life Insurance Trust, wherein the payment is made using funds provided to it by the Pass Through Business Entity;
(k) an instrument providing that the Master Life Insurance Trust advance funds to the grantor(s) of the Revocable Life Insurance Trusts for the purchase of one or more Single Premium Immediate Annuities whose measuring life is the same measuring life as the life insured under the life insurance policy(ies) owned by the Revocable Life Insurance Trust;
(l) optionally, an instrument providing that, upon achieving one or more pre-specified Investment Milestones, the Issuer is to be provided, upon the deaths of the Insureds, a portion of the death benefits provided by the life insurance policies, and that any LIBAC^{SM} distributions, or portions thereof, optionally may be retained by the Pass Through Business Entity for the time period within which such Investment Milestones must be reached, or may be distributed wholly or partially to Investors until the Issuer reaches one or more Investment Milestones, at which point the Issuer may be entitled to a portion or all of such distributions;
(m) an instrument providing that, upon the deaths of the Insureds, all or a remaining portion of the death benefits provided by the life insurance policies will be paid to the Investors, and that the Investors will be provided at least with a full return of their principal investment and, optionally, with an additional return on their principal investment; and
(n) optionally, an instrument providing that, the Issuer may receive a right to share in LIBAC^{SM} distributions upon reaching its pre-specified Investment Milestones, such that upon reaching such Investment Milestones, it may book its aliquot interest in the Pass Through Business Entity as an asset on its balance sheet.

75. A method for one or more investors to invest in a business entity, with potential returns on their investment while minimizing a risk of a loss of invested capital comprising:
(a) providing by one or more Insureds ranging from about 65 to about 85 years in age one or more in force life insurance policies that insure the lives of the Insureds, or of the Insureds' spouses, and that have one or more beneficiaries, wherein the beneficiaries are persons who, on the date of the issuance of the life insurance policies, have an insurable interest in the lives of the Insureds, or their spouses;
(b) forming, or providing, a Pass Through Business Entity, optionally, by an Issuer;
(c) in a securities Offering, offering for sale to one or more Investors in exchange for a payment by the Investors of investment funds:
(1) by the Pass Through Business Entity of ownership interests in the Pass Through Business Entity, wherein a portion of the total investment funds invested by the Investors is paid to the Pass Through Business Entity for such ownership interests, and wherein such portion is an amount that is required to acquire one or more LIBAC^{SM} Assets having a combined face value that is similar to, equal to, or in excess of, the total amount of the invested funds; and
(2) by the Issuer, one or more classes of “equity interests,” “debt securities,” or a combination of “equity interests” and “debt securities,” wherein a portion of the total investment funds invested by the Investors is paid to the Issuer for such “equity interests,” “debt securities,” or combination of “equity interests” and “debt securities,” and wherein such portion is a remaining net balance of the total investment funds paid by the Investors;
(d) causing the Insureds to enter into a contract agreeing to sell their interest in the LIBAC^{SM} Assets and obligating them to use a portion of funds provided to them by the Pass Through Business Entity to purchase one or more Single Premium Immediate Annuities, wherein each Insured is the measuring life of the annuity(ies) such Insured purchases and is sole annuitant of the annuity(ies) and the beneficiary of the annuity(ies), or each Insured is the measuring life of the annuity(ies) and one or more other entities to be acquired by the Pass Through Investment Entity are the beneficiary(ies), wherein the Single Premium Immediate Annuities generate one or more annuity payments in amounts that are sufficient to pay:
(i) premiums that become due for the life insurance policies;
(ii) administrative expenses;
(iii) incidental taxes related to Single Premium Immediate Annuity income; or
(iv) any combination of two or more of (i), (ii) and (iii);
and wherein the Single Premium Immediate Annuities terminate upon the deaths of the Insureds, or at the related life insurance policy maturity date if earlier than the death of the Insured whose life is the measuring life for both the life insurance policy and the related Single Premium Immediate Annuity;
(e) advancing funds to the Insureds by the Pass Through Business Entity for the purchase of one or more Single Premium Immediate Annuities;
(f) providing LIBAC^{SM} distributions to the Pass Through Business Entity comprising:
(1) death benefits under the life insurance policies, wherein the life insurance policies have a combined face value that is similar to, equal to, or in excess of, the total amount of funds invested by the Investors in the Offering; and
(2) annuity payments made under the one or more Single Premium Immediate Annuities that are similar to, equal to, or in excess of, the amount of money that is required to pay:
(i) premiums due for the life insurance policies;
(ii) administrative expenses;
(iii) taxes due on the income portion of Single Premium Immediate Annuity payments; or
(iv) any combination of two or more of (i), (ii) and (iii);
wherein the LIBAC^{SM} distributions are provided to the Pass Through Business Entity, and provide funds for distribution to each Investor for a repayment of a portion or all of the principal amount of the Investor's investment made pursuant to the Offering, and wherein the Issuer, upon achieving one or more pre-specified Investment Milestones in connection with the “equity interests,” “debt securities,” or combination of “equity interests” and “debt securities” may, optionally:
(i) be entitled to collect a portion of the LIBAC^{SM} distributions, such that it may book an aliquot interest in the Pass Through Business Entity as an asset on a balance sheet; and
(ii) upon the deaths of one or more of the Insureds, be provided with a portion or all of the death benefits provided by the life insurance policies;
wherein any LIBAC^{SM} distributions from such death benefits, or portions thereof, may be retained by the Pass Through Business Entity for the time period within which such Investment Milestones must be reached, or may be distributed wholly or partially to Investors until the Issuer reaches one or more Investment Milestones, at which point the Issuer may be entitled to a portion or all of such distributions.

76. A computer implemented method for one or more investors to invest in a business entity, with potential returns on their investment while minimizing a risk of a loss of invested capital comprising:
(a) providing by one or more Insureds ranging from about 65 to about 85 years in age one or more in force life insurance policies that insure the lives of the Insureds, or of the Insureds' spouses, and that have one or more beneficiaries, wherein the beneficiaries are persons who, on the date of the issuance of the life insurance policies, have an insurable interest in the lives of the Insureds, or their spouses;
(b) forming, or providing, a Pass Through Business Entity, optionally by an Issuer;
(c) in a securities Offering, offering for sale to one or more Investors in exchange for a payment by the Investors of investment funds:
(1) by the Pass Through Business Entity of ownership interests in the Pass Through Business Entity, wherein a portion of the total investment funds invested by the Investors is paid to the Pass Through Business Entity for such ownership interests, and wherein such portion is an amount that is required to acquire one or more LIBAC^{SM} Assets having a combined face value that is similar to, equal to, or in excess of, the total amount of the invested funds; and
(2) by the Issuer, one or more classes of “equity interests,” “debt securities,” or a combination of “equity interests” and “debt securities,” wherein a portion of the total investment funds invested by the Investors is paid to the Issuer for such “equity interests,” “debt securities,” or combination of “equity interests” and “debt securities,” and wherein such portion is a remaining net balance of the total investment funds paid by the Investors;
(d) causing the Insureds to enter into a contract agreeing to sell their interest in the LIBAC^{SM} Assets and obligating them to use a portion of funds provided to them by the Pass Through Business Entity to purchase one or more Single Premium Immediate Annuities, wherein each Insured is the measuring life of the annuity(ies) such Insured purchases and is sole annuitant of the annuity(ies) and the beneficiary of the annuity(ies), or each Insured is the measuring life of the annuity(ies) and one or more other entities to be acquired by the Pass Through Investment Entity are the beneficiary(ies), wherein the Single Premium Immediate Annuities generate one or more annuity payments in amounts that are sufficient to pay:
(i) premiums that become due for the life insurance policies;
(ii) administrative expenses; or
(iii) incidental taxes related to Single Premium Immediate Annuity income;
(iv) any combination of two or more of (i), (ii) and (iii);
and wherein the Single Premium Immediate Annuities terminate upon the deaths of the Insureds, or at the related life insurance policy maturity date if earlier than the death of the Insured whose life is the measuring life for both the life insurance policy and the related Single Premium Immediate Annuity;
(e) advancing funds to the Insureds by the Pass Through Business Entity for the purchase of one or more Single Premium Immediate Annuities;
(f) providing LIBAC^{SM} distributions to the Pass Through Business Entity comprising:
(1) death benefits under the life insurance policies, wherein the life insurance policies have a combined face value that is similar to, equal to, or in excess of, the total amount of funds invested by the Investors in the Offering; and
(2) annuity payments made under the one or more Single Premium Immediate Annuities that are similar to, equal to, or in excess of, the amount of money that is required to pay:
(i) premiums due for the life insurance policies;
(ii) administrative expenses;
(iii) taxes due on the income portion of Single Premium Immediate Annuity payments; or
(iv) any combination of two or more of (i), (ii) or (iii);
wherein the LIBAC^{SM} distributions are provided to the Pass Through Business Entity, and provide funds for distribution to each Investor for a repayment of a portion or all of the principal amount of the Investor's investment made pursuant to the Offering, and wherein the Issuer, upon achieving one or more pre-specified Investment Milestones in connection with the “equity interests,” “debt securities,” or combination of “equity interests” and “debt securities” may, optionally:
(i) be entitled to collect a portion of the LIBAC^{SM} distributions, such that it may book an aliquot interest in the Pass Through Business Entity as an asset on a balance sheet; and
(ii) upon the deaths of one or more of the Insureds, be provided with a portion or all of the death benefits provided by the life insurance policies;
wherein any LIBAC^{SM} distributions from such death benefits, or portions thereof, may be retained by the Pass Through Business Entity for the time period within which such Investment Milestones must be reached, or may be distributed wholly or partially to Investors until the Issuer reaches one or more Investment Milestones, at which point the Issuer may be entitled to a portion or all of such distributions.

77. The method of claim 76, wherein the computer is a personal computer.

78. A method for one or more investors to invest in a business entity, with potential returns on their investment while minimizing a risk of a loss of invested capital comprising:
(a) providing by one or more Insureds ranging from about 65 to about 85 years in age one or more Revocable Life Insurance Trusts, for which the Insured or the Insured's spouse is the Grantor, containing one or more in force, non-variable or other life insurance policies that insure the lives of the Insureds, or of their spouses, and that have one or more beneficiaries, and wherein the beneficiaries of the Revocable Life Insurance Trusts are individuals who, on the date of the issuance of the non-variable life insurance policies, have or had an insurable interest in the lives of the Insureds or their spouses;
(b) forming or providing a Pass Through Business Entity, optionally by an Issuer;
(c) forming, optionally by the Pass Through Business Entity, of a Master Life Insurance Trust, wherein the Pass Through Business Entity funds this trust, optionally using a minority portion of the total funds invested by the Investors;
(d) in a public or private securities Offering, offering for sale to one or more Investors in exchange for a payment by the Investors of investment funds:
(1) by the Pass Through Business Entity of new-issue “membership interests” in the Pass Through Business Entity, wherein the portion of the total investment funds paid to the Pass Through Business Entity by the Investors for such “membership interests” is, optionally, a minority of the total investment funds paid by the Investors, and is an amount required to acquire one or more LIBAC^{SM} Assets having a face value similar to, equal to, or in excess of, the total amount of the invested funds; and
(2) of one or more classes of “equity interests” and/or “debt securities” of the Issuer, wherein the portion of the total investment funds paid to the Issuer by the Investors for such “equity interests” and/or “debt securities” is, optionally, a majority and remaining net balance of the total investment funds paid by the Investors;
(e) causing the Insureds of the Revocable Life Insurance Trusts to enter into a contract to sell their trust powers and obligate them to use a portion of the funds provided to them by the Master Life Insurance Trust to cause the Revocable Life Insurance Trust to purchase one or more Single Premium Immediate Annuities, wherein each Insured is the measuring life of the related annuity(ies), and the beneficiaries of the annuities are the Revocable Life Insurance Trusts, wherein the Single Premium Immediate Annuities generate one or more annuity payments in amounts that are sufficient to pay the premiums that become due for the non-variable life insurance policies, the fees for the trustee(s) of the Revocable Life Insurance Trusts, the fees of the trustee(s) of the Master Life Insurance Trust, Pass Through Business Entity administrative expenses and/or any income tax that becomes due on that portion of proceeds of the annuity that are taxable, and wherein the Single Premium Immediate Annuities terminate upon the death of the Insureds, or at the related life insurance policy maturity date if earlier than the death of the Insured;
(f) acquiring, by the Master Life Insurance Trust, trust powers to control one or more Revocable Life Insurance Trusts and having the grantor Master Life Insurance Trust named as a beneficiary of the Revocable Life Insurance Trusts and, thereby, obtain a right to receive LIBAC^{SM} distributions comprising:
(1) death benefits under the non-variable life insurance policies owned by each Revocable Life Insurance Trust, wherein the non-variable life insurance policies have a combined face value that is similar to, equal to, or in excess of, the total amount of funds invested by the investors in the offering; and
(2) annuity payments made under one or more Single Premium Immediate Annuities (each a “SPIA”) that are similar to, equal to, or in excess of, the amount of money that is required to pay:
(i) premiums due for the non-variable life insurance policies;
(ii) trust administrative expenses;
(iii) Pass Through Business Entity administrative expenses;
(iv) taxes due on the income portion of Single Premium Immediate Annuity payments; or
(v) a combination of any two or more of (i), (ii), (iii) and (iv);
wherein the LIBAC^{SM} distributions provide funds for distribution to each Investor for a repayment of the a portion or all of the principal amount of the Investor's investment made pursuant to the Offering, and wherein the Issuer may, optionally, be entitled to collect a portion of the LIBAC^{SM} distributions, depending upon the Issuer achieving one or more pre-specified Investment Milestones in connection with the “equity interests,” “debt securities,” or a combination thereof, issued by the Issuer as part of the Offering;
(g) assigning by the grantors of the Revocable Life Insurance Trusts all rights to amend, change and/or revoke the Revocable Life Insurance Trusts and all rights and powers to sell, convey, transfer and/or assign trust powers to the Master Life Insurance Trust through which the written agreements governing the Revocable Life Insurance Trusts are amended to:
(1) optionally, name the Master Life Insurance Trust as the sole beneficiary of the Revocable Life Insurance Trusts;
(2) optionally, name a new trustee(s) of the Revocable Life Insurance Trusts, wherein the new trustee(s) are designated by the Master Life Insurance Trust;
(3) provide that the beneficiary has the power to amend, change and/or revoke the Revocable Life Insurance Trust in the future; and
(4) provide that the beneficiary has the right and power to sell, convey, transfer and/or assign trust powers in the future;
(h) using funds provided to it by the Pass Through Business Entity for the payment of such funds to the Insureds by the Master Life Insurance Trust in exchange for an assignment of all of the rights and powers of the Insureds to amend, change, revoke and/or supplement the trust agreements that govern the Revocable Life Insurance Trusts and the right and power to sell, convey, transfer and/or assign trust powers;
(i) advancing funds, by the Master Life Insurance Trust, to the grantor(s) of the Revocable Life Insurance Trusts for the purchase of one or more Single Premium Immediate Annuities pursuant to the terms of the Revocable Trust Powers Assignment contract;
(j) optionally, upon achieving one or more pre-specified Investment Milestones, providing to the Issuer upon the deaths of the Insureds a portion of the death benefits provided by the in force non-variable life insurance policies, wherein any LIBAC^{SM} distributions, or portions thereof, optionally may be retained by the Pass Through Business Entity for the time period within which such Investment Milestones must be reached or may be distributed wholly or partially to Investors until the Issuer reaches one or more Investment Milestones, at which point the Issuer may be entitled to a portion, up to all, of such distributions;
(k) providing to the Investors upon the deaths of the Insureds all or a remaining portion of the death benefits provided by the in force non-variable life insurance policies, wherein the Investors are provided at least with a partial or full return of their principal investment and, optionally, with an additional return on their principal investment; and
(l) optionally, providing to the Issuer a right to share in LIBAC^{SM} distributions upon reaching its Investment Milestones, such that upon reaching such Investment Milestones, it may book its aliquot interest in the Pass Through Business Entity as an asset on its balance sheet.
